(19) United States
(12) Patent Application Publication
(10) Pub. No.: US 2012/0239420 A1
(43) Pub. Date: Sep. 20, 2012

(54) CLINICAL DECISION SUPPORT SYSTEM

(76) Inventors: WOLF H. STAPELFELDT, Jacksonville, FL (US); Marc R. Reynolds, Kirtland, OH (US); Bhaswati Ghosh, Shaker Heights, OH (US); George F. Takla, Strongsville, OH (US); Bishoy M. Magdalla, Strongsville, OH (US)

(21) Appl. No.: 13/422,730

(22) Filed: Mar. 16, 2012

Related U.S. Application Data
(60) Provisional application No. 61/454,208, filed on Mar. 18, 2011.

(51) Int. Cl. G06Q 50/22

(52) U.S. Cl. 705/2

(57) ABSTRACT

A system to facilitate decision support can include dynamic expression data stored in memory. The dynamic expression data includes a plurality of expressions, each expression representing a different condition that varies as a function of one or more variables. A user interface can be programmed to assign a given expression to a selected visualization space in response to a user input. A data interface can receive values from at least one data source for each variable in the given expression. An output engine can be programmed to populate the selected visualization space with information based on each condition defined by the given expression that has been assigned to the selected visualization space.

### CROSS-REFERENCE TO RELATED APPLICATION

This application claims the benefit of U.S. Provisional Patent Application No. 61/454,208 filed on Mar. 18, 2011, and entitled SYSTEMS AND METHODS FOR PROVIDING CLINICAL DECISION SUPPORT, which is incorporated herein by reference in its entirety.

### TECHNICAL FIELD

This disclosure relates to providing clinical decision support.

### BACKGROUND

A clinical decision support system provides an interactive knowledgebase system to assist physicians and other health professionals in various health care related tasks. One purpose of such systems is to assist health care providers at the point of care. For example, some systems can help determine diagnoses, analyze various patient information as well as to monitor conditions of on-going procedures. With the complexity of various clinical workflows and differences that may exist at various facilities, however, resistance has existed at various institutions in making such decisions support systems part of the ordinary work flow. In addition to being difficult to integrate into existing workflows, many systems suffer from providing rigid rules and formulations which further tends to prevent the flexibility and scalability of such systems.

### SUMMARY

This disclosure relates to providing clinical decision support.

A system to facilitate decision support can include dynamic expression data stored in memory. The dynamic expression data includes a plurality of expressions, each expression representing a different condition that varies as a function of one or more variables. A user interface can be programmed to assign a given expression to a selected visualization space in response to a user input. A data interface can receive values from at least one data source for each variable in the given expression. An output engine can be programmed to populate the selected visualization space with information based on each condition defined by the given expression that has been assigned to the selected visualization space.

As another example, a graphical user interface (GUI) can provide clinical decision support. The GUI can include a GUI element associated with a patient encounter, the GUI element being presented in a visualization space and programmed to provide a status feature for a given alert condition that graphically discriminates between an alert condition and a non-alert condition for a given alert guidance based on a given expression that is assigned to the given alert guidance. After the alert condition is resolved, the status feature can be changed gradually over a predetermined time from indicating the alert condition to indicating the non-alert condition.

### BRIEF DESCRIPTION OF THE DRAWINGS

FIG. 1 depicts an example of a decision support system (DSS).

FIG. 2 depicts an example of a guidance system that can be implemented in a DSS.

FIG. 3 depicts an example of a system for generating a visualization space.

FIG. 4 depicts an example of a system that can be utilized for generating expressions for use in a DSS.

FIG. 5 depicts an example of a configuration system that can be utilized for assigning inspections to provide guidance for the DSS.

FIG. 6A depicts a screen shot of an example GUI that can be utilized for setting properties of an expression for use in a DSS.

FIG. 6B depicts a screen shot of an example GUI that can be utilized for creating a dynamic expression for use in a DSS.

FIG. 6C depicts a screen shot of another example GUI that can be utilized for creating a dynamic expression for use in a DSS.

FIG. 7 depicts a screen shot for an example GUI that can be implemented for assigning expressions for providing guidance content for a DSS.

FIG. 8 depicts a screen shot of an example GUI that can be implemented for assigning expressions and for providing layouts in a DSS.

FIG. 9 depicts an example of a layout that is driven by an expression for use in a DSS.

FIG. 10 depicts a screen shot of an example GUI that can be implemented for configuring different types of guidances in a DSS.

FIG. 11 depicts a screen shot of an example GUI that can be utilized for selecting decision support guidance for a user's active encounters.

FIG. 12 depicts a screen shot of an example GUI that can be utilized for setting alert notifications for a user.

FIG. 13 depicts a screen shot of an example GUI for setting alert notifications for guidance that may be provided in a DSS.

FIG. 14 depicts a screen shot of chart preferences that can be configured for a user of a DSS.

FIG. 15 depicts a screen shot of an example monitoring system that can be utilized for accessing a DSS.

FIG. 16 depicts a screen shot of an example of an active encounter window such as in a response to triggering the decision support system from the GUI of FIG. 15.

FIG. 17 depicts a screen shot of example guidance information that can be presented in a DSS.

FIG. 18 depicts a screen shot of an example encounter GUI demonstrating alert guidance that can be provided in a DSS.

FIG. 19 depicts an example of a dashboard GUI showing guidance that can be provided for a plurality of encounters.

FIG. 20 is a screen shot demonstrating the GUI of FIG. 20 for a persistent alert condition.

FIG. 21 is a screen shot demonstrating the GUI of FIG. 19 showing a gradual change for a graphical encounter element following resolution of an alert condition.

FIG. 22 is a screen shot demonstrating an example of an operations GUI dashboard that can be implemented in a decision support system.

### DETAILED DESCRIPTION

This disclosure relates to systems and methods for providing decision support. The systems and methods can be utilized to provide clinical decision support in real time to caregivers and corresponding supervisors. The systems and methods can be used for providing guidance in the form of decision support for one or more patients, such as for a preoperative care, perioperative care, postoperative care as well as for any other patient care setting. In the example context of a healthcare enterprise system, the systems and methods can be implemented, for example, as computer-executable instructions (e.g., one or more applications) layered above the medical record keeping system of the healthcare. The systems and methods can include interfaces to collect information from a plurality of diverse devices (e.g., patient monitoring equipment), healthcare record keeping systems, and other information sources. Unlike many existing systems, the systems and methods disclosed herein can bring the most pertinent information together in new ways and in a timely manner to allow best evidence to be practiced as a result.

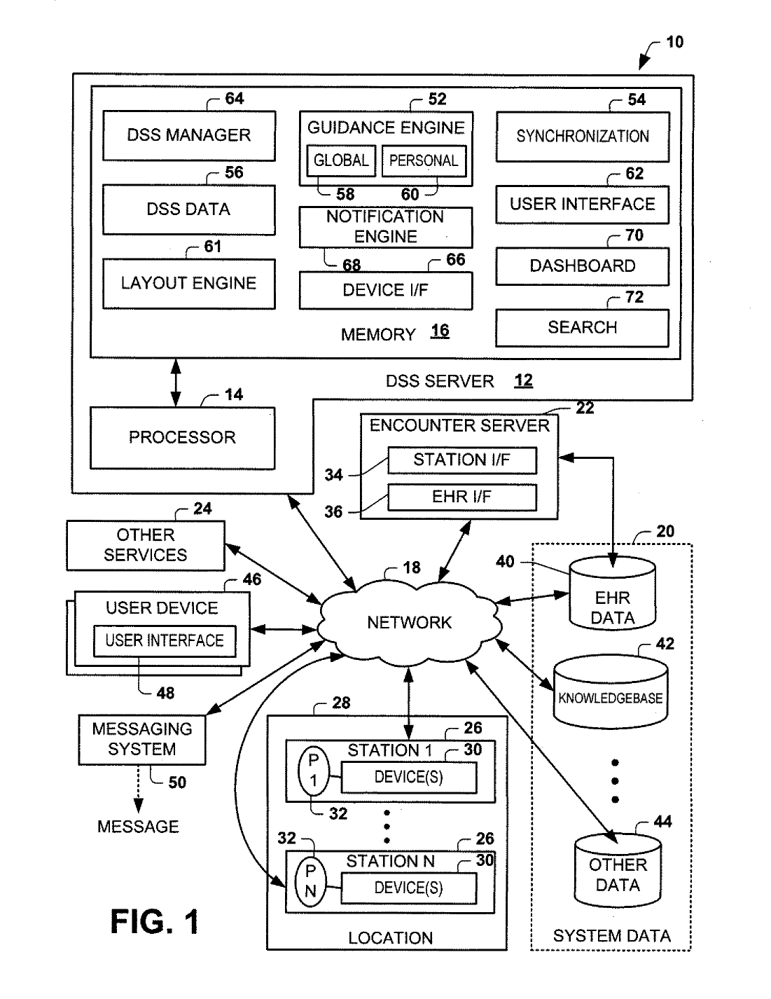

FIG. 1 depicts an example of a decision support system (DSS) 10. In the example of FIG. 1, the DSS 10 includes a DSS server 12. The server 12 can include one or more processor 14 and memory 16. The memory 16 can store data and machine readable instructions that can be executed by the processor 14. For example, the memory 16 can comprise physical memory, such as can reside on the processor 14 (e.g., processor memory), random access memory or other physical storage media (e.g., CD-ROM, DVD, flash drive, hard disc drive, etc.) or a combination of different memory devices that can store the machine readable instructions. The memory 16 further can be implemented within a single machine, as depicted in FIG. 1, or it can be distributed across multiple machines. The data utilized for implementing the systems and methods described herein can also be stored in the memory 16 or in some other arrangement of one or more memory structures that are accessible for use by the DSS 10.

The DSS server 12 can be connected to a network 18 such as to provide for communication between the DSS server and various services, devices and data stores that can collectively form the system 10. The network 18 can be a local area network, a wide area network, or a combination of different various network topologies, which may include physical transmission media (e.g., electrically conductive, optical fiber media or the like) and/or wireless communications media, that can be utilized for communicating information. The network or at least a portion of the methods and functions implemented thereby can operate in a secure manner (e.g., behind a firewall separated from public networks) and/or utilize encryption for data communications. As a further example, the DSS server 12 can be implemented as a computing cloud in which the functions and methods and data can be accessible as a service via the network 18.

In the example of FIG. 1, the DSS server 12 can employ the network 18 to access system data 20, an encounter server 22, as well as one or more other services generally indicated at 24. These other services 24 can correspond to various other servers that can store and provide information pertinent to a given patient encounter or to a patient's health condition, more generally. Such other services 24 may also execute methods and functions that can be utilized by the DSS server 12, such as via corresponding application interfaces (APIs). The particulars of such other services 24 can vary according to the particular purpose of the DSS 10.

The DSS server 12 can also obtain information from a plurality of stations 26, demonstrated as station 1 through station N, where N is a positive integer denoting the number of stations. The stations 26 can be associated with one or more locations 28. For example, each location 28 can correspond to a portion of a facility (a floor, a ward or the like), a facility itself or a plurality of different facilities residing in different geographic locations for which the DSS 10 can be configured to provide clinical decision support.

In the example of FIG. 1, each station 26 can include a number of one or more devices 30. Each of the devices 30 can be associated with an encounter for a given patient 32, demonstrated as Patient P1 through Patient PN. Thus in this example each station 26 can include a given patient. Although it is understood that more than one patient could be associated with a given station in other examples. The DSS 10 can be configured to provide decision support for any number of one more patient encounters. As used herein a patient encounter corresponds to a record that is maintained by the DSS 10 for each patient 32 during a time period for a given visit, such as can include their time in a given station 26 (e.g., a perioperative period) or a plurality of different stations during respective different phases of the encounter.

Each of the devices 30, for example, can obtain real time information about a patient condition that can be monitored during each active patient encounter. Such real time information can include, for example arterial blood pressure, venus blood pressure, heart rate, temperature, respiration rate, pulse oximetry as well as any other parameters that may be pertinent to the health condition of a patient during the encounter. The DSS server 12 can obtain information directly from such devices 30 such as through a device interface configured to acquire real-time information. Alternatively or additionally, the DSS server can obtain corresponding patient data from the encounter server 22 or another data source that may collect and process information from one or more of the devices 30.

As an example, the encounter server 22 can include a station interface 34 that can be utilized to acquire information from one or more of the devices 30. The encounter server 22 can obtain such data at a desired sample rate that might vary according to the type of information, such as depending on the rate that each of the devices samples such data. For example, blood pressure readings may be performed by a blood pressure monitor every five minutes whereas pulse oximetry or heart rate can be sampled at much higher rates. The encounter server 22 can store information from such devices 30 data as part of a patient encounter in memory associated with the encounter server.

The encounter server 22 can also include an electronic health record (EHR) interface 36 that can be utilized to retrieve patient information from an EHR database 40. For example, the encounter server 22 can employ the EHR interface 36 to pull patient encounter data, as well as other pertinent patient records from the EHR database 40 (e.g., patient demographic information, patient medical history, or the like). The DSS server 12 can employ also the encounter server (e.g., as middleware) 22 to obtain relevant patient information from the EHR database, such as via an encounter interface (e.g., an API). The encounter server 22 can also be programmed to store relevant encounter data in the EHR database 40.

In addition to health record data that may be stored in the EHR database 40, the DSS server 12 can also access a knowledgebase 42 or one or more other data sources, indicated at 44. The knowledgebase 42 can be utilized to access a variety of reference texts, medical publications, guidelines, policies and procedures and care algorithms that may be utilized by users of the system 10. Such information contained in the knowledgebase 42 or the other data sources 44 may be accessed via a search engine, for example. The DSS server 12 can make such information available to its users via dynamic or configurable links. As an example, the DSS server 12 can present patient encounter information to a user via one or more web (e.g., html) pages that contain dynamic links (e.g., hypertext links) to predefined resource locations (e.g., uniform resource locations (URLs)) at which pertinent information corresponding to the system data 20 can be provided. As disclosed herein, the DSS server 12 can be programmed to automatically select the information according to the real-time conditions of the patient, preferences of the user, guidance expressions and other information related to an event that is occurring at a given one of the respective stations 26. The DSS server 12 can provide an encounter GUI (e.g., a page) that is populated with such selected information and/or links to such information.

In the examples disclosed herein, the DSS server 12 can be implemented in a context of a perioperative patient management system. For instance, the DSS server 12 can provide timely patient encounter information, guidance and alerts to users so that informed decisions can be made in a time-critical environment. As mentioned above, data specific to each active patient encounter (associated with the respective station 26) can be acquired by the DSS server 12 from a variety of sources, such as including the encounter server 22, EHR data 40, the knowledgebase 42, other data sources 44 and/or other services 24 that may provide pertinent information for the decision support process for each active patient encounter. In addition to presenting patient information, operations information about relevant personnel (e.g., staffing ratios, types of personnel assigned to a given encounter and the like) can also be generated and provided to authorized users such as in the form of an interactive graphical user interface (GUI).

Authorized users can also employ one or more corresponding user device 46 to access information generated by the DSS server 12. There can be any number of user devices 46 that can access the information from the DSS server 12. A given user device 46 can include a user interface 48 that allows the user to access the functions and methods implemented by the DSS server 12 as well as to retrieve related content information. The user interface 48, for example, can include a web browser (or a thin client application) that can be provided dynamic links for accessing the functions and methods corresponding to the DSS server 12. It is to be appreciated that such user device 46 can be a computer, a work station, as well as a mobile device (e.g., a smart phone, laptop or tablet computer) that can run a corresponding application programmed to access the functions and methods associated with the DSS server 12. The user device 46 can be located in a corresponding local station where the patient resides (e.g., in an operating room (OR) or other type of room or location) 26 as well as can be implemented as a remote device, that can access the information produced by the DSS server 12, such as by accessing corresponding pages via a web browser or other application.

The DSS server 12 can also employ a messaging system 50 to send messages to respective users. For example, the user device 46 can also be a pager to which one or more alphanumeric pages can be sent from the DSS server via the messaging system 50. In this example, the messaging system 50 can correspond to a hospital paging system. The messaging system 50 can also be implemented as a text messaging system, an automated phone/voice messaging system, and/or an email messaging system for providing corresponding messages to respective user devices.

The DSS 10 can also provide alerts, other notifications and relevant information, corresponding to patient conditions that are monitored by the DSS. The alerts can be sent via the messaging system 50 to the users that can be received via the user device 46. As further disclosed herein, alerts can correspond to global types of alerts and guidance. Additionally, or alternatively, the DSS server 12 can be configured by a given user to provide personalized alerts and guidance to the given user. As a result, the system 10 can be customized according to the individual preference of a given user.

Authorized individual users having supervisory control or similar authorization may also be able to configure global types of guidance and global alerts that will be populated to guidance GUIs for users of the system 10. In this way, the DSS 10 can help improve patient outcomes, such as by reducing mistakes, reducing potential oversights and providing a mechanism for more timely recognition of conditions that may require user intervention.

The DSS server 12 can include a guidance engine 52 programmed to evaluate information and data pertinent to an evolving patient condition for each active encounter. As mentioned above, the guidance engine 52 can receive the patient encounter data from various devices 30, which may be directly monitoring each patient's conditions, as well as from data available from other sources such as the system data 20, the encounter server 22 and other services 24. The guidance engine 52 can be programmed to analyze such information based on one or more expressions and compute decision support data that can be employed to populate a visualization space that is presented to one or more users. The guidance engine 52 can also be programmed to search the system data 20 or other sources for pertinent patient information, guidelines and procedures relevant to current circumstances of the active patient encounter, such as based on an expression that has been assigned to provide such passive guidance. For example, the DSS system 10 can automatically generate passive guidance for an active patient encounter by populating the visualization space with relevant information and/or links to information stored in the knowledgebase 42 or in the other data 44. Data acquired by the DSS server 12 for each station 26 can be stored in the memory 16 or another database, such as may be part of the system data 20.

As a further example, the DSS server 12 can include a synchronization module 54 that can be utilized to control sampling data from the encounter server 22 as well as from each of the stations 26 and other services 24 that may be configured to monitor patient conditions. As one example, a programmable sampling time period can be specified for timing retrieval of information by the synchronization module 54 of the DSS server and other services, such as the encounter server 22 during which the DSS server, via the synchronization module 54, can retrieve information. For instance, a mutually agreed upon predetermined time window, such as between the 15^{th} and 50^{th} second can be set and programmed into the synchronization module to minimize disruption with the ongoing activity of the encounter server 22. In order to ensure that the time window remains synchronized with the time base of the encounter server 22, time synchronization can occur periodically such as every fifteen minutes or other predetermined time period that is greater than the sampling time period.

Examples of some conditions that can be monitored by the devices 30 at each station 26 can include: EKG, pulse oximetry, blood pressure, temperature, respiration rate, or other parameters that can be monitored directly from the patient. Additional information can be obtained from the devices 30 such as based upon values that can be calculated including, for example a bi-spectro index (BIS), mean arterial pressure (MAP), end-tidal anesthetic condition (MAC). Alternatively, this and other information and parameters can be computed by the DSS server 12 based on data retrieved from available sources, such as including the system data 20 and the devices 30.

As a further example, the following table demonstrates a sample set of some data parameters (e.g., variables) that can be acquired by the DSS server 12 and respective data sources where values of such parameters may be obtained. The DSS server 12 thus can acquire data according to timing controlled by the synchronization module and provide decision support guidance based on expressions that have been created using such variables.

| Parameter | Data Source |
|---|---|
| Airway Summary | Encounter Parameter Data |
| Allergies | Encounter Parameter Data |
| Anesthesia Type | Encounter Parameter Data |
| ARKS Bolus Meds | Encounter Bolus Meds |
| Arterial Diameter | Encounter Monitor Data |
| Arterial Heart Rate | Encounter Monitor Data |
| Arterial Mean | Encounter Monitor Data |
| Arterial Sys | Encounter Monitor Data |
| BIS | Encounter Monitor Data |
| CO2 | Encounter Monitor Data |
| CVP | Encounter Monitor Data |
| Desflurane | Encounter Monitor Data |
| dPP | Other Data |
| dPP2 | Other Data |
| EHR Medical History (ICD-9 code) | EHR database |
| EPIC Medications | Encounter Medications |
| Fi O2 | Encounter Monitor Data |
| HR | Encounter Monitor Data |
| Isoflurane | Encounter Monitor Data |
| Mech Min Vol | Encounter Monitor Data |
| Medical History | Encounter Parameter Data |
| NBP Dia | Encounter Monitor Data |
| NBP Mean | Encounter Monitor Data |
| NBP Sys | Encounter Monitor Data |
| Patient Position | Encounter Parameter Data |
| Regional Block Type | Encounter Parameter Data |
| Sevoflurane | Encounter Monitor Data |
| Sp O2 | Encounter Monitor Data |
| spO2 Variability | Encounter External Data |
| Temp 1 | Encounter Monitor Data |
| Temp 2 | Encounter Monitor Data |
| Warming Devices | Encounter Parameter Data |

In the above table, the data sources including the term “Encounter” can be obtained from the encounter server, for example.

The guidance engine 52 can be utilized to provide passive guidance, dynamic (e.g., active) guidance as well as a combination of passive and dynamic guidance to a user via a user device. The passive guidance can correspond to presenting the information directly as obtained from a device or data source, such as can be presented on a user device 46 in the form of text, graphics or a combination of texts and graphics showing various patient conditions. The passive guidance can also include links to pertinent information that can be obtained from the system data 20 or other services, such as can include links to various documents that may be relevant to the patient's 32 evolving condition, patient history or other information that can be obtained for an active patient encounter from the system data 20.

As a further example, the guidance engine 52 can be programmed to provide guidance, including dynamic or passive guidance, in response to detecting an adverse condition associated with a patient. For example, the guidance engine 52 can retrieve pertinent passive information (e.g., documents, procedures, or the like) analysis of one or more expressions that employ variables, such as can correspond to a pre-existing condition, one or more vital signs or other indication of a predefined patient condition for a given patient 32. For example, passive guidance can include a checklist of “best practices” for procedures that may be implemented for a given patient condition.

The dynamic guidance can be provided based on analysis of one or more expressions that employ the relevant input data that has been obtained, such as via the synchronization module 54 from the devices 30, encounter server 22 or other services 24 for a given patient encounter. The DSS server 12 can retrieve, track patient data and provide guidance separately for each of a plurality of independent patient encounters, which data can be stored in the memory 16 when other data such as to facilitate first encounter analysis end up improving quality of care. The guidance engine 52 thus can be programmed to populate a corresponding visualization space with pertinent guidance, such as including both the dynamic and passive content to the user based upon the preprogrammed expressions that have been enabled for each encounter.

The data acquired for each patient encounter can be stored in the memory 16 as DSS data 56. The DSS data 56 can also include variables that can be utilized for generating expressions, expressions that have been generated and assignment data for assigning expressions for controlling analysis and guidance implemented by the guidance engine 52. The guidance for a given active encounter can include global guidance as well as personal guidance that is customized for an individual user, as demonstrated by the global guidance module 58 and the personal guidance module 60.

The global guidance module 58 can be configured to control guidance that is provided for each member of a group, such as can include one or more users or across an enterprise, by establishing a set of global criteria upon which the guidance engine 52 will generate guidance. As mentioned, such global guidance can include passive and dynamic guidance. The global guidance module 58, for example, can be utilized to define parameters or other criteria, such as in the form of dynamic expressions that control what guidance content is provided. The global guidance can include guidance populated in a visualization space (e.g., a screen or an area of the screen) based on analysis of the DSS data 56. The guidance can also include other forms of guidance, such as audible or a combination of audible and visual guidance. For instance, the global guidance module 58 can be programmed to implement expressions selected (e.g., by a supervisor or a team of users) for providing generally applicable guidance, such as can be based upon best practices evidence or other policies and procedures for a given institution or practice area.

The personal guidance module 60 can be utilized by an individual user to control types of personalized guidance (e.g., passive guidance or dynamic guidance) that can be provided based upon user-defined variables. In this way, each user may establish a set of personalized criteria that employ user-configured expressions based on which guidance can be provided to such user. Different users can employ different instances of the same personal guidance criteria (e.g., corresponding to respective expressions). Each instance can employ the same thresholds or different thresholds for providing their personal guidance. An authorized user can also convert a personal guidance expression to a global guidance expression, such as via a corresponding user interface 62.

The DSS system 10 can also include a layout engine 61 that is programmed to control populating the layout of a visualization space. The layout can include a static layout, a dynamic layout or a combination of static and dynamic layouts. A static layout, for example, can be configured to provide guidance and support data for each of one or more predefined positions in a visualization space. For example, a user can select a set of locations (e.g., rooms) in a facility that will be used and the layout engine 61 can populate the visualization space with a GUI element to provide guidance information for each selected location. In this example, the layout engine 61 can populate the visualization space with the GUI element for each location statically (e.g., regardless of the results of any expressions). The layout engine 61 can also dynamically populate the visualization space based on one or more expressions that are assigned to visualization space. For example, a user can assign an expression to a place holder in the visualization space and only populate the space with a corresponding GUI element depending on the results of the assigned expression. Thus, if the expression criteria is met, the layout engine 61 can dynamically add a GUI element and if (or when) the criteria is not met any longer, the GUI element can be removed from the visualization space. In this way, the DSS system 10 can employ one or more selected expressions to dynamically control populating a layout based on encounter data. The DSS system 10 can employ a common set of expressions used by the guidance engine and the layout engine to drive both dynamic guidance and dynamic layout that is provided to the visualization space.

A user can employ the user interface 62 of the DSS server 12 that can access corresponding tools, such as may be part of a DSS manager 64. The DSS manager 64 can correspond to functions and methods that can be utilized to program or various aspects of the DSS system 10, such as disclosed herein. The accessibility of various functions and methods that can be accessed by a given user can depend upon an individual's authorization or role within the system. For example, there can be any range of roles that can be established within the system 10, which may be based upon existing authentication systems for an enterprise or network in which the system 10 is being implemented. For instance, a supervisor or other individual with a sufficient level of authorization can set the parameters for controlling the global guidance module 58.

A system administrator further may be able to create and configure interfaces, such as including one or more device interfaces 66, to control communication and retrieval of data from various resources in the system 10. The device interface 66 can be configured to provide access to the output data provided by the one or more devices 30 that may be utilized in a given active station 26. The device interface 66 thus can create a communications channel via the network for retrieving relevant data. The retrieved data can include raw data, processed data or a combination of raw and process data that can be presented in the form of content to a given user. Additionally, an individual user may also employ the user interface 62 to access personal preferences via the DSS manager 64, such as to establish parameters that control the personal guidance module 60 for such user, set up user devices 46 and other personal settings.

By way of further example, each user that is logged into the system 10 is recognized and their personal preferences and settings can be utilized for controlling what dynamic and passive guidance may be provided to the individual according to the personal guidance module 60 and other configuration settings that may be user-configurable. Both global and personal settings can be stored as DSS parameters in the DSS data 56 of the memory 16.

A notification engine 68 can be configured to establish mechanisms to be utilized for communicating information to a given user. Similar to the guidance engine 52, the notification engine 68 can employ global and personal notification methods that are applied to users logged into the system 10. Such global notification mechanism can include on-screen displays that can be color coded, flashing or otherwise indicate a condition that requires attention by the user-physician. The notification engine 68 can also send messages to a given user via the corresponding messaging system 50 in response to detecting certain conditions. Such conditions can be determined by the guidance engine 52, which can correspond to global guidance or personal guidance that may be set by the user.

A user can specify more than one mechanism to be utilized for sending notifications. For example, a user can employ the DSS manager 64 to configure the notification engine 68 to send each type of active alert notifications for the respective user via one or more specified destination, such as via text messaging, paging, email, and/or other mechanisms via which a user can receive information. Thus, in response to instructions to send a notification (e.g., as determined by the guidance engine 52), the notification engine 68 can send such notification to an individual user or to a group of users according to the each destination specified in the notification parameters that have been established for each notification.

As an example, a given user that is logged into the system 10 may be an owner of a patient encounter (e.g., having responsibilities for the patient 32 (P1) in station 26). The responsible user may have a supervisor or other assistants that have also logged in and have been assigned to such station. The notification engine 68, in response to an alert being triggered via the guidance engine 52, can send the notification to each associated user via the messaging system 50. As mentioned, each user can be sent the notification in a unique manner as established by their personal notification settings. In this way, alerts and notifications can be made to appropriate personnel for more timely recognition of conditions such that appropriate action can be made promptly. As disclosed herein, in addition to providing such alert notification, the guidance engine 52 can also provide passive guidance information that can help guide the user.

If the guidance engine 52 determines the occurrence of an alert condition for a given patient 32 (e.g., based on analysis of an expression assigned to such alert condition), the corresponding alert condition can be presented to one or more users via the user device 46. Once an alert condition has been presented to a user, the user can employ the user interface 48 of the user device 46 to acknowledge the condition, which provides a return acknowledgement message to the guidance engine 52. A user can intervene to remedy the condition, obtain additional information that may be presented to the user via the user interface 48 (e.g., passive guidance in the form of documents, information or policies and procedures) and take appropriate action to address the condition accordingly. Once the user believes that the condition has resolved itself or has taken steps to remedy the situation, a user can manually clear and remove the alert condition.

While the foregoing example has been described in the terms of an alert condition for an individual patient 32, the system 10 can also include a dashboard module 70 that can present information associated with a plurality of encounters or stations to one or more users, such as a supervisor of a floor or a ward of operating rooms. For example, the dashboard module 70 can populate a layout with GUI elements and related information in a format that can be easily understood by a supervisor. The representation of the floor can correspond to the individual floor plan of the facility and the operating rooms therein or locations (e.g., rooms) can be arranged generically in rows and columns. As disclosed herein, the DSS server 12 can employ the layout engine 61 to configure a layout to correspond to a desired arrangement of stations 26 (e.g., a floor plan), in which the operating rooms or other types of stations reside.

Each station 26 in the layout, for example, can be represented as an encounter GUI element that can be color coded to provide a status indicator associated with each such station. For instance, a green color can be utilized to indicate that everything is within an expected operating parameters, yellow can indicate a warning condition and red can be utilized to indicate an alert condition. Additionally, icons or other features can be dynamically presented in the GUI element for each station 26 based on guidance expressions that have been assigned. For instance, icons can be utilized to present a user with an indication of the patient condition, such as including real-time alert conditions or other relevant patient information provided based on analysis by the guidance engine 52 determining a corresponding alert condition exists.

Any number of one or more criteria can be established for providing decision support guidance that can be presented via the dashboard for each of the plurality of stations. If an alert condition exists, a corresponding icon associated with such condition can be dynamically presented in the encounter GUI element to indicate a particular condition. A key or legend can be provided in the dashboard to indicate the type of condition responsible for the alert as represented by each icon or other graphical feature. By hovering a cursor over a given icon additional information about the respective alert condition can be provided to the user (e.g., as a pop-up window). The dashboard user can take appropriate action based on the information presented via the dashboard, such as may include contacting an individual who is assigned to such station (the owner), contacting the station. This can be in addition to automatic notifications sent by the DSS server 12 as disclosed herein.

Additionally, the alert condition can provide impetus for monitoring a given station to ensure that appropriate action is taken to resolve the condition in a timely manner. For example, after a condition has been resolved for a given station 26, the guidance engine 52 can change the condition from an alert condition to a warning condition such that the station user interface element can change from red (the alert condition) to a yellow color (a warning color) to indicate that the condition has resolved. When a condition has been resolved, but has not been cleared (corresponding to a warning condition—such as a yellow color), an individual can hover a cursor over the user interface element or icon exhibiting the warning condition and be presented information about the previous alert condition or conditions.

For example, for any new problems populated on the dashboard, the guidance engine 52 can control the icon or other graphical feature within the encounter GUI element to differentiate the new alert from a persisting alert. For example, the icon or other graphical feature for the new alert can be presented with a white frame and/or be blinking for a predetermined time (e.g., about 10 seconds). An audible sound can also be provided via one or more user devices 46 (e.g., a beeping sound) to indicate the new problem for such time. Additionally, the guidance engine can provide encounter GUI element with a graphical frame that can be adjusted to indicate different temporal characteristics of a given alert condition. For instance, a pronounced black frame for an encounter GUI element can be provided for a set duration (e.g., the first minute of the alert condition) to indicate that a new alert condition is occurring. Alternatively, a red frame can be employed to indicate if a given alert condition persists beyond a predetermined time (e.g., for at least 5 minutes). The guidance engine can also populate the encounter GUI element with a timer, such as to indicate the number of minutes in the left lower corner that a given problem has persisted.

As a further example, if a patient has hypertension and the hypertension resolves itself, by hovering over the icon for the corresponding station, a given user can be informed of the extent of the hypertension, the time period that the hypertension occurred and when it was resolved. Additional information about its resolution as well as other vitals can also be provided, if so configured. The user can be given an option to clear the warning condition or take other action, understanding that a person may be prone to a given condition.

As indicated above, some alert conditions may automatically resolve themselves without intervention. For example, if a patient's monitored condition (e.g., based on data from one or more devices 30) that triggered the alert falls back to within normal parameters, the alert condition can be considered to have resolved itself. In response to detecting resolution of the alert condition, the guidance engine 52 can cause the encounter GUI element to change from an alert mode (e.g., a red color) to a caution mode (e.g., a yellow color). The guidance engine 52 can control the encounter GUI element to gradually change from its caution mode to a normal mode—provided that no alert condition is triggered for the respective encounter during such transition. A user can terminate the gradual transition manually, such as in response to a user input to clear the alert condition.

By way of further example, the guidance engine can control encounter GUI element to transition gradually over a predetermined time from a first color (e.g., a yellow color) that indicates a caution mode to a second color (e.g., a green color) that indicates that the encounter has proceeded to within expected parameters (e.g., no alert conditions). Gradual in this particular context refers to the color changing over a substantially continuous spectrum of colors aligned in a color palette between respective non-alert indicating colors (e.g., from yellow to green). Other types of gradual transitions in status features (e.g., changing shape between different graphical icons) can be utilized depending on the differences between features used to indicate a caution mode and a normal mode for a given encounter. The predetermined time for the gradual transition can be fixed (e.g., a default time, such as 15 minutes) or it can be programmable, such as can be set for each alert condition. While the GUI element is transitioning, a user is thus informed that an alert condition had previously existed by had resolved itself. A user can activate or hover over the GUI element, which can cause the guidance engine 52 to present additional information about the previous alert condition.

The example alert conditions mentioned above generally correspond to analysis based on expressions that have been assigned to a given alert condition and are determined by the guidance engine 52. Additionally, an alert condition can be manually triggered in response to activation of an alarm, which can be automatically triggered or be triggered manually (e.g., by a health care personnel, a patient, or visitor). For instance the alarm activation can be received via the device interface 66 that is configured to monitor an alarm system. The guidance engine 52 can be programmed to indicate such alarm condition to indicate an emergency situation in response to detecting that the alarm has been triggered. For example, the guidance engine 52 can indicate the alarm activation via the dashboard module 70, such as by presenting the encounter GUI element as blinking in red, along with a persistent audible notification. This condition can be cleared in response to the alarm system being reset.

The DSS server 12 can also include a search module 72 that can be utilized to identify and locate content pertinent to a given patient encounter. The search module can provide the content directly or it can be provided via hypertext links or otherwise. For example, the search module 72 can correspond to a commercially available or proprietary search engine that can be utilized to query the system data 20 or other resources for information and guidance that may be pertinent to the patient condition based upon the encounter data or a patient history data. For example, the search module 72 can query any number of one or more databases and such queries may be run periodically in response to the evolving data that is collected by the DSS server for each patient encounter.

Individual instances of the search module 72 thus can be utilized for each patient encounter for retrieving information pertinent for each respective patient. In addition to implementing such queries in response to the real-time information, such data can be analyzed (e.g., by the guidance engine 52) to detect trends or time varying parameters that may indicate specific conditions based on which the search module 72 can in turn issue one or more queries to locate relevant information that is presented to the user via the encounter GUI. Thus, as described herein, the search module 72 may employ the results of expressions implemented by the guidance engine 52 to implement corresponding searches such that the information being presented to the user at a given user device 46 is timely and relevant to the patient's current and evolving condition.

The search module 72 further can be customized for a given user, via the user interface 62 such as to implement custom search strings for obtaining relevant data for a given station 26. Corresponding queries thus can be created in response to the guidance engine 52 detecting the occurrence of a given condition to which the search string has been associated.

In addition to information about patient health, the guidance engine 52 can also provide information relating to equipment and the devices 30 in each station such as in response to detecting a potential malfunction of such devices or the user of such devices. For instance, the users can be health care providers that are expected to perform certain functions. Expressions can be programmed to trigger an alert if certain protocols and procedures are not followed within expected levels of performance.

As an example, the guidance engine 52 can be programmed (e.g., via a corresponding expression) to detect a situation when a patient's blood pressure has not been taken within a predetermined time period (e.g., about 5 to 10 minutes). If the blood pressure reading has not been taken within such predetermined period, based on the expression, an alert can be triggered and a notification engine 68 can distribute a notification. Concurrently with such notification and determination that blood pressure has not been taken the search module 72 can selectively query one or more databases such as forming part of the system data 20, to obtain information relevant to the failure of the blood pressure to be taken, to provide additional assistance to the user relevant to the current alert condition. Alert conditions determined in response to failure of users (e.g., health care providers—staff) to perform certain functions within expected time parameters can be presented by the dashboard module 70, such as in encounter GUI elements of an operational dashboard. In this way, users and supervisors can ensure that appropriate actions are taken according to established (e.g., evidence-based) protocols that can be captured in corresponding expressions.

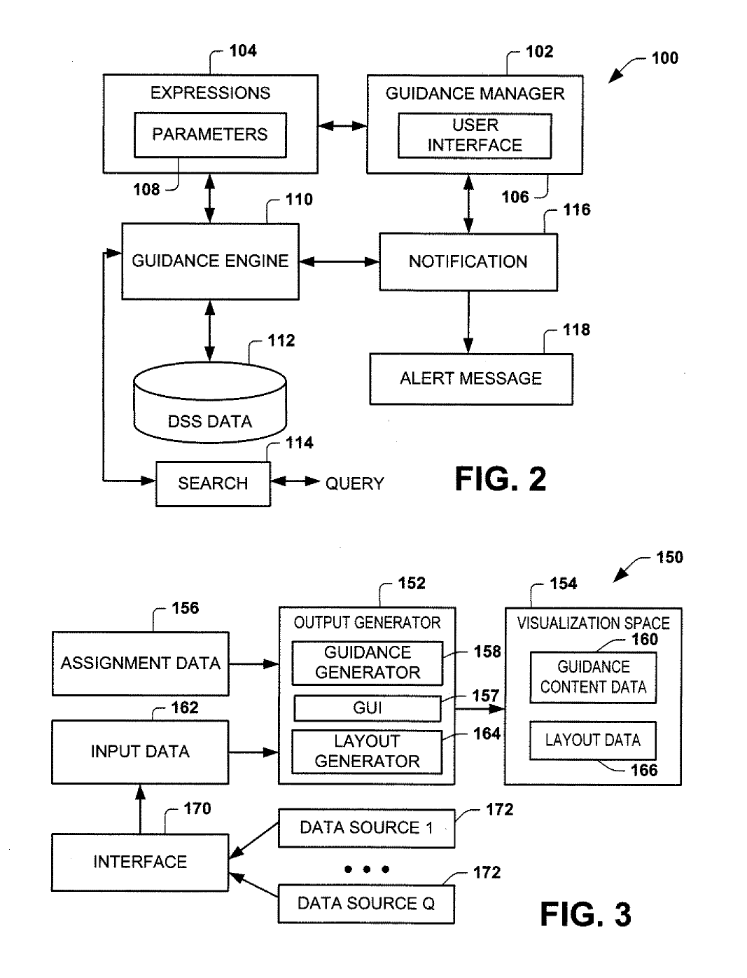

FIG. 2 depicts an example of a guidance system 100 that can be implemented in the DSS of FIG. 1 for controlling the type and manner of guidance provided to each user. The guidance system 100 includes a guidance manager 102 that provides tools for configuring expressions 104 that control the type of guidance and under what circumstances such guidance would be provided via the DSS. The guidance manager 102 can include a user interface 106 that provides a mechanism for a user to access the configuration tools of the guidance manager 102 for creating, modifying or deleting the expressions (e.g., criteria for triggering guidance and support) 104. For instance, the user interface 106 can be utilized to create an expression and corresponding parameters (e.g., one or more variables) 108 for each such expression. The parameters can include any one or more of the conditions and data that are being monitored by the DSS for each station.

The expressions 104 and associated parameters 108 utilized to provide decision support can vary from station to station as different stations may provide different information and vitals for a given patient. Additionally, different equipment can be utilized in different stations such that the interfaces for collecting such information and the underlying data may be different. Some of the expressions 104 may be predefined in the system, such as corresponding to default expressions and global guidance criteria. The parameters 108 of such expressions can be preprogrammed to provide mandatory forms of decision support. Alternatively, parameters for one or more expressions can be modified via the user interface 106 to provide customized personal guidance.

A guidance engine 110 applies the expressions to DSS data 112 to provide guidance to the respective users pertinent to the patient's condition, users associated with the patient encounter, or information about devices. As mentioned, the DSS data 112 can be acquired from a variety of sources including from station devices (devices 30 of FIG. 1), the encounter server 22, system data 20 as well as other services 24 that may be implemented within the system. The guidance can be provided as passive guidance, such as can include locating pertinent information and resources. The guidance engine 110 can instruct the search module 114 to conduct one or more queries based upon one or more condition detected by the guidance engine 110 and based on the results provide corresponding passive guidance. Additionally, the guidance engine 110 can provide instructions to a notification module 116 to generate one or more alert messages or other forms of notification to the user (or users) assigned to a given encounter.

As described herein, the alert message 118 can be provided in a variety of forms including presentation on a screen that is located within the station, via a web page that is provided to a user device 46 (FIG. 1) as well as may include distribution to one or more users via one or more corresponding messaging system. The notification module 116 can be configured by each respective user to define one or more distribution mechanisms for sending alert messages 118 to each respective user.

FIG. 3 depicts an example of a visualization system 150 for controlling generation of a visualization space 154 to provide decision support. The system 150 includes an output generator that is programmed to provide the visualization space based on assignment data 156 that programmatically associates expressions (expression data 204—see FIG. 5) with guidance content and/or layout. The assignment data 156, for example, can be generated as shown herein with respect to FIG. 5. The assignment data 156 thus identifies which one or more expressions (e.g., stored in expression data) have been assigned to provide a certain type of guidance or to control a layout based upon such one or more expressions. The assigned expressions can also be configured via the output generator such as in response to utilizing a GUI 157 that can set parameter values, logical relationships, thresholds and other parameters associated with the expressions.

The output generator 152 can include a guidance generator 158 that can generate corresponding guidance content data 160 based upon assignment data 156 that relates one or more expressions to respective guidance. The corresponding guidance can include passive as well as dynamic guidance as disclosed herein. For example, the guidance generator 158 thus can employ input data 162 and in turn generate corresponding guidance content data 160 as part of the visualization space 154. The input data can be received from a variety of data sources 172 such as can be provided by respective interface 170. In the example, of FIG. 3, the data sources 172 are demonstrated as data source 1 through data source Q, where Q is a positive integer denoting the number of data sources. For example, the interface 170 can be interfaced to hardware sources that provide data (e.g., devices 30 of FIG. 1), software data sources (e.g., EHR data, 40, knowledgebase data 42 and/or other data 44 of FIG. 1), or a combination of hardware and software data sources. For example, an electronic health record can be accessed via the interface 170 and operate as a corresponding data source 172. Real time monitoring equipment in a station can also operate as a data source 172 such as can be retrieved via a corresponding interface 170. Various other types of data sources can also be utilized within the context of the decision support system and visualization system 150.

The output generator 152 can also include a layout generator 164 that is programmed to control a corresponding layout data 166 in the visualization space 154. For example, the layout generator 164 can employ the assignment data 156 and dynamically generate corresponding layout data 166 based upon the values of input data 162 that is mapped into expressions that have been assigned to respective layout.

As an example, a layout can include static GUI elements that correspond to fixed GUI elements that can provide guidance data. Additionally or alternatively, a given layout can include dynamic GUI elements that are populated or not populated in the respective place holders of the visualization space 154 depending on the values of input data that is utilized in the expressions that have been assigned to such layout. In this way only certain GUI elements and the correspondence data may be populated in the visualization space for the given layout. For instance, an expression can be created to select a proper subset of available encounters meeting certain criteria based on the assigned expression and associated data (e.g., based on the assignment data 156 and input data 162).

As one example, a user-defined layout can be populated dynamically with encounter GUIs, such as may coincide with a given physicians expertise. As another example, expressions can be created and assigned to a selected layout to dynamically populate a given layout with GUI elements based on a combination of patient data, health condition information, location or other criteria that may be available as variables for the expressions. In this way, a dynamic robust set of expressions can be created, accessed and utilized to dynamically control the layout of the visualization space 154.

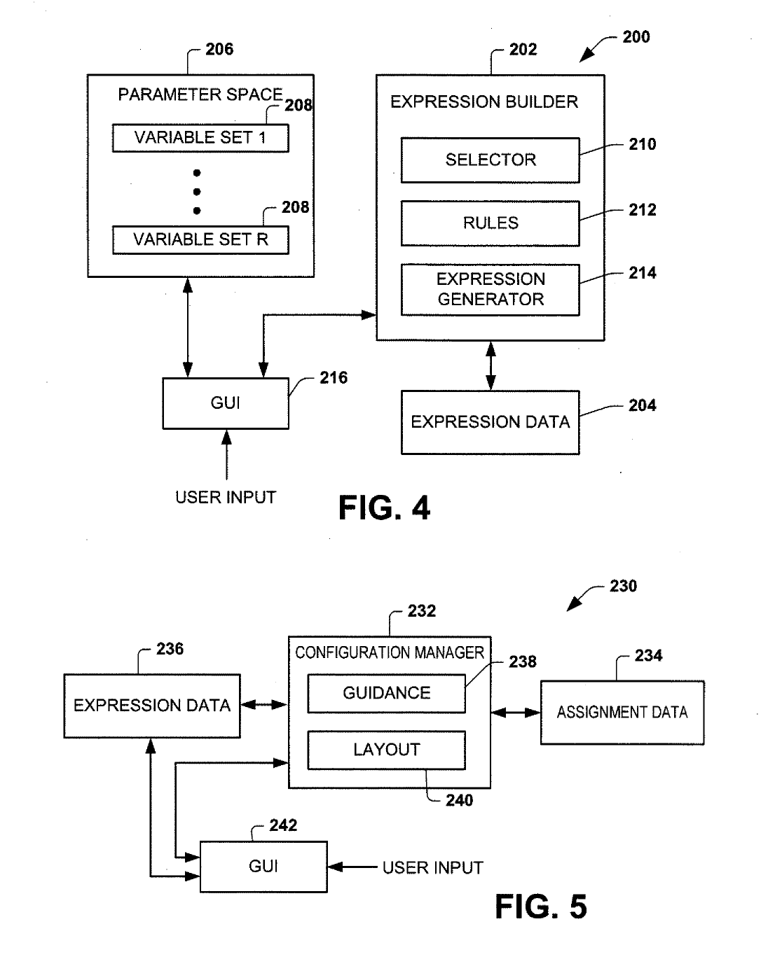

FIG. 4 depicts an example of a system 200 that can be utilized for generating expression data 204. As disclosed with respect to FIG. 3, expressions represented by the expression data as can be assigned to a layout or other guidance content to provide guidance, such as may be presented in a visualization space. The system 200 can include an expression builder 202 that generates the expression data 204 based upon variables contained within a parameter space 206. For example, the parameter space 206 can include a plurality of different sets of variables 208, demonstrated as variable set 1 through variable set Q, where Q is positive integer denoting the number of sets. The different variable sets 208 can be organized according to various topics.

By way of example, the variable sets 208 can correspond to various types of data and variables that can map to data input into or accessible by the DSS system. For instance, a variable set can relate to aspects of an encounter, patient information (e.g., co-morbidities, diagnostic information, demographic information, such as from an EHR) and/or data acquired from devices (e.g., that can be monitored or entered by a user). The variable sets 208 can also include variables corresponding to locations in a facility as well as variables relating to different aspects of business operations. The variable sets 208 can also include variables, logical operators, mathematical operators, other variables, and other expressions already created. The variables in each of the variable sets 208 can comprise variables static values associated with an encounter, such as strings, time ranges, time relative to a given event or other time, bolus drug names, infusion drug names, typed numbers or the like.

A given variable set 208 can be selected to reveal a list of available variables within each variable set. There can be any number of variable sets and variables within each set which can be added to according to guidance requirements within the decision support system.

The expression builder 202 can include a selector 210 that is programmed to select one or more variables from a selected variable set 208, such as in response to a user input such as can be provided via a GUI 216. As a given variable is selected for inclusion in a given expression via the selector 210, the expression builder 202 can employ corresponding rules to control options associated with the expression and the selected variable.

For example, each variable can correspond to one or more particular data type such as may include as string, real number, integer, float or the like. Depending upon the type of variable or possible types for the variable options can be available via the selector to configure the expression further. Such selections can be made via a drop down menu or other types of selections provided by the GUI 216. Corresponding variables and data types, operators and relationships between variables can be selected in response to a user input via the GUI 216.

In addition to using the selector 210 to select variables for a given expression, a user can employ the GUI 216 to access functions and methods in the selector for configuring values, operators, ranges or the like for use in the expression. The set of available types of operators, values and ranges can vary depending upon application of rules 212 to the variable and other parameters associated with the variable that may constrain what can be implemented. Any number of one or more variables from any number of one or more variable sets 208 may be combined within the expression builder via the GUI 216 to provide a resulting expression, which itself may include one or more expressions.

As one example, the GUI 216 can be utilized to drag and drop graphical user interface elements corresponding to variables into an expression container interface element. The relative placement of the variables within expression container interface elements of the GUI element can control the resulting expression and relationships between variables. Once the expression has been configured and set according to user requirements, an expression builder 214 can generate the corresponding expression and store it in memory as the expression data 204. Each expression can be kept private, if desired, or it may be globally available or shared to one or more users of the DSS. drag and drop a the variable into an to create a relationship between two or more of the variables for the expression

FIG. 5 depicts an example of an assignment system 230 that can be utilized to assign expressions to provide guidance or control a layout for use in the DSS. The assignment system 230 includes a configuration manager 232 that is programmed to generate assignment data 234 such as can be utilized by the system 150 of FIG. 3 as disclosed herein. The configuration manager 232, for example, can generate the assignment data 234 in response to a user input selecting one or more expressions from expression data 236. The selected expression(s) can be assigned to a selected part of a visualization space, such as to control a layout or guidance content populated therein.

By way of example, the configuration manager 232 can include a guidance component 238 that is be utilized to assign one or more expressions (e.g., stored in memory as expression data 236) based on which corresponding guidance content can be provided (e.g., by the output generator 152 of FIG. 3). As disclosed herein, the guidance can include personal guidance or global guidance. The parameters of the expression that is configured can be stored as the assignment data 234. The assignment data can be stored with the expression data to which it is assigned or it can be otherwise programmatically associated (e.g., linked with the expression. For instance, to configure and assign an expression to provide guidance, a user can employ a GUI 242 to select a corresponding expression and apply it to provide a given type of guidance. The guidance component 238 can also be programmed to enable a user to create or modify properties of the expression, such as can include naming the type of guidance, setting ranges and values associated with the guidance and setting the type of guidance that is to be provided (e.g., personal or global guidance).

The configuration manager 232 can also include a layout component 240 that is utilized to create assignment data 234 to control and manage a layout for a visualization space. The layout component 240 can generate static layout elements, dynamic layout elements or a combination of static and dynamic layout elements for a given visualization space. For the example of a dynamic layout, a user can employ the GUI 242 to select a corresponding expression and apply it to a place holder in a layout for configuring the visualization space. The layout component 240 thus can generate corresponding assignment data that can be implemented by the DSS (e.g., by the layout generator 164 of FIG. 3) to control the layout of the corresponding visualization space dynamically based upon the expressions that have been assigned to such space and the values of variables for the expressions. For the example of a static layout, a user can employ the GUI 242 to employ the layout component 240 to define a set of fixed objects (e.g., encounter GUI elements) that will remain populated in the visualization space regardless of input data. That is, the objects of a static layout remain populated, although the guidance and other content presented for such objects can vary dynamically such a based on global and personal guidance that has been assigned via the guidance component 238.

Additionally, the configuration manager 232 can employ a common set of expressions stored as an expression data 236. Thus, the guidance component 238 and the layout component 240 can select from such common set of expressions to control both the guidance that is populated into a visualization space as well as dynamically control a layout that can be populated to a visualization space. In this way, users are familiar with the expressions and how they can be created and utilized, such as to control both layouts and guidance that can be provided.

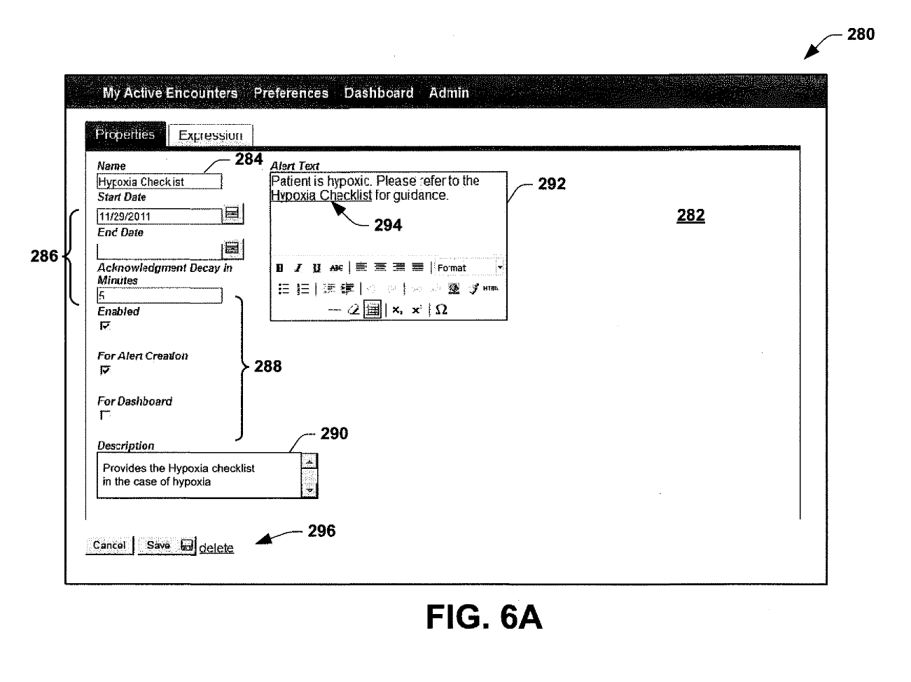

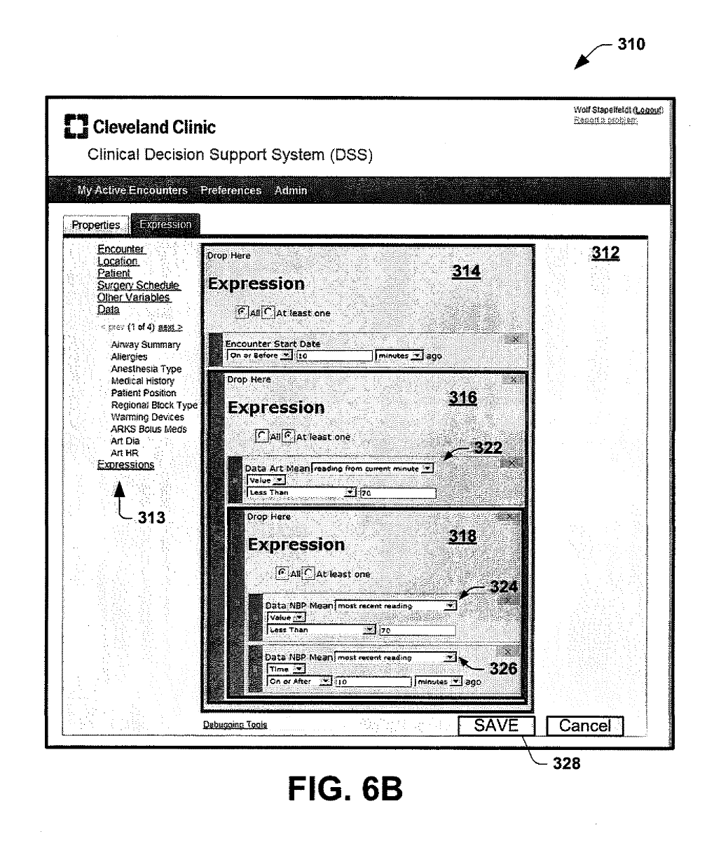

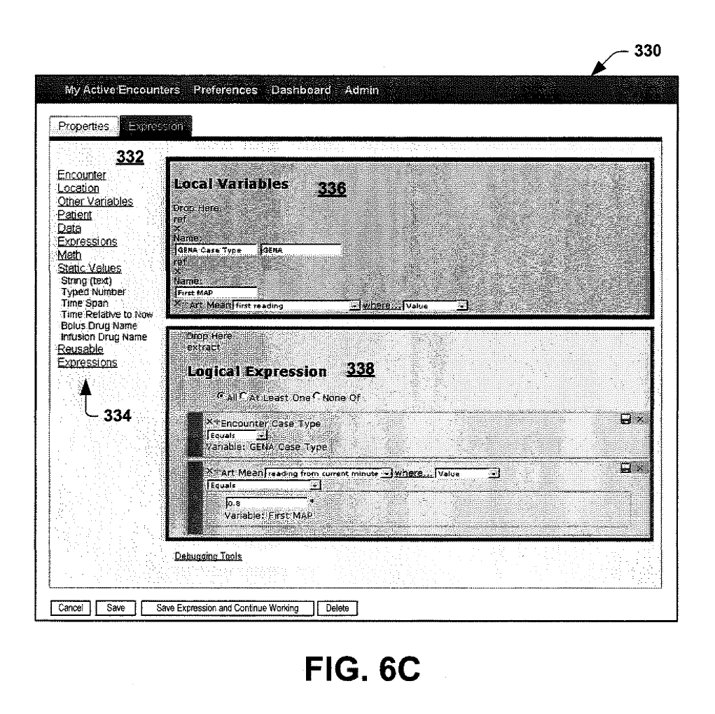

By way of further example, FIGS. 6A, 6B and 6C demonstrate examples of GUIs that can be utilized to create and/or modify an expression. FIG. 6A depicts an example of a GUI 280 for setting properties for guidance, such as corresponding to an alert condition. The GUI includes a properties tab 282 that is configured to enter various properties for the guidance. For example, the properties can include a GUI element 284 for a name, GUI elements 286 for a start date and an end date. When the properties are being set, a user can also specify in a GUI element 288 whether the expression is available for assignment for a dynamic layout, a dynamic expression or both. For the example shown in FIG. 6A when the expression is for providing an alert, a GUI element 292 can be used to insert text to provided when the expression is satisfied for triggering the alert condition. The text can also include a link to relevant information that can be activated by a user provide additional guidance (e.g., passive guidance) related to the alert condition. User control elements 296 can also be provided for saving, cancelling or deleting the guidance.

FIG. 6B depicts an example screen shot of a GUI 310 that includes an expression tab 312 that can be employed for generating an expression. The functions and methods implemented in the tab 312 can be part of the DSS manager (e.g., corresponding to expression builder 202 of FIG. 4) that is utilized for creating and configuring expressions that can be utilized by the guidance engine for dynamically providing guidance or dynamically populating layouts, as described herein. In the example of FIG. 6B, the expression tab 312 can be implemented as style sheet or other document that includes a plurality of fields that define parameters for variables selected from available sets of variables 313. In the example of FIG. 6B the sets of variables include encounter variables, location variables, patient variables, surgery schedule, other variables, data variables, and expressions. A user thus can employ a pointing device or other user interface to select variables from any of the variable sets 313. As shown, the data variable set has been activated to provide a list of available data variables (lists 1 of 4).

The expression can include a single variable or it can include multiple variables that can be interrelated by their placement (e.g., via a drag and drop operation). The expression thus can be a nested expression that employs a plurality of variables. Each expression can be configured individually according to user-defined criteria.

In the example of FIG. 6B, the GUI 310 is configured to include three expressions 314, 316, and 318. For instance, the expression 314 can include a user interface element (e.g., a user input field) 320 to set an encounter start date that forms part of the expression. The expression 316 includes a user interface element 322 to set criteria demonstrated as including a threshold for mean arterial pressure for a patient, as read from the current minute. While each of the expressions 314 and 316 include a single criteria (e.g., encounter time and mean arterial pressure), the expression 318 is demonstrated as itself including multiple user interface elements 324 and 326 for entering plurality of criteria for such expression. In this example, the expression includes two criteria relating to both a timeliness of a non-invasive blood pressure (NBP) reading and a value of most recent reading. These two criteria of expression 318 are aggregated, such as by selected Boolean logic, which can be dictated by the relative position of each expression relative to each other. In each of the examples, the Boolean logic is demonstrated as a selection of “all” or “at least one” of the terms in each expression, corresponding to logical AND and logical OR operators, respectively. Other types of Boolean and combinational logic, mathematical operators, local variables, shared variables and other methods of relating one or more variables can also be utilized to define an expression. For example, the GUI 310 can be extensible through plug-in and can create domain-independent calculations by generating a programmatic syntax tree, such as can be expressed in XML or other languages. The expression for such syntax tree can then be translated into any appropriate machine language and executed to yield a corresponding result. As disclosed herein, the result can be utilized to drive a layout, other guidance content or a combination thereof.

As described herein, each expression elements 314, 316 and 318 can be utilized to set one or more variable and thresholds that are being monitored by DSS for an encounter (e.g., data from the encounter server, data from devices or other services that may be implemented in the DSS). Once the desired expression has been created, such expression can be saved into the DSS data for use by the guidance engine, such as in response to activating a control GUI element (e.g., save) 328.

FIG. 6C depicts a screen shot of another example GUI 330 that includes expression tab 332 that can be employed for generating an expression. The expressions tab 332 can be part of the DSS manager (e.g., corresponding to expression builder 202 of FIG. 4) and access functions and methods for creating and configuring an expression, which can be utilized by the guidance engine for dynamically providing guidance or dynamically populating layouts, as described herein similar to the example in FIG. 6B.

In the example of FIG. 6C, the expression tab 332 demonstrates a different type of expression being generated that involves a predicate and variables. In the present example, the Static Values variable set 334 has been activated to provide a list of available static value variables, such as can include, string, typed number, time span, time relative to now, bolus drug name, and infusion drug name. Other static variables may be utilized depending on application requirements, for example.

In the example of FIG. 6C, the expression being created via the GUI 330 includes an expression element 336 for local variables and an expression element 338 corresponding to a logical expression. Any number of these and other expression elements can be aggregated into a given expression according to the desired characteristics of the expression being created. The local variables expression element 336 includes user interface fields for defining parameters for the local variables, which in this example includes identifying a string variable for a type of encounter (e.g., a “GENA case type) and another variable for a first reading for a value of a mean arterial pressure (MAP) corresponding to a value of a first reading. These local variables defined via the expression element 336 can then utilized in one or more other expression element 338 that implements a user-defined logical expression from the local variables. The local variables that are created can remain local or become shared variables, such as can be stored into the “Other Variables” variable set at 334 for subsequent use.

In the example of FIG. 6C, the logical expression 338 thus defines a conditional statement in which the variable encounter case type is equal to the local variable “GENA Case Type” (e.g., indicating a general anesthesia type of encounter) and the variable ART MEAN is set 0.8 times another local variable “First Map.” This mathematical expression or other forms of mathematical expressions (e.g., division, addition, subtraction, square root or other type of expression) can be selected from the “Math” variable set. By defining local variables via the expression builder, the local variables can be referenced in a given expression such that predicate logic and other multi-order functions can be implemented (e.g., the logical expression being created at 338). These and other complex orders of expressions thus can be created easily via the expression builder, such as may involve logical expression and other types of expressions disclosed herein. For instance, it is contemplated that n-order expressions (n denoting the number of variables) can be created to represent surface functions corresponding to evidence based practices or user-specific preferences.

As disclosed herein, certain expressions can be implemented as global guidance while others can be personalized guidance for a respective user. Once expressions have been created, the list of such expressions can be made available to all users such that they may be selected and assigned to dynamically provide guidance or control a layout of a visualization space. Additionally, a given user may take an existing expression and modify it, such as by adjusting thresholds up or down such that the preferences for such expression will be stored and utilized for encounters that are assigned to such user. Expressions can also be customized for each patient encounter, such as to accommodate unique patient circumstances.

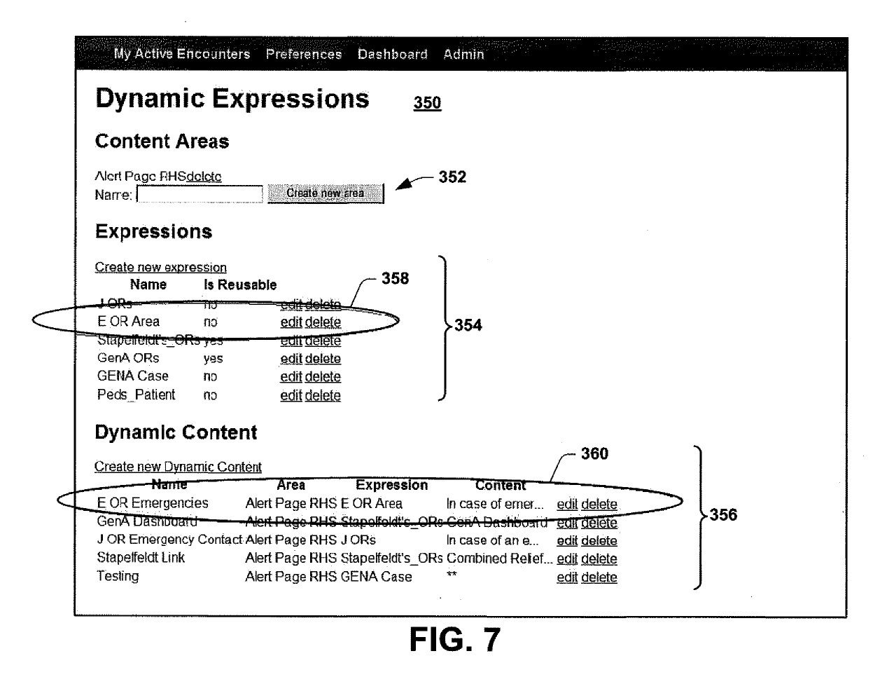

FIG. 7 depicts a screen shot demonstrating an example GUI 350 that can be utilized for managing and assigning dynamic expressions to provide guidance content in a DSS. In the example of FIG. 7, a user can employ a pointing element to configure and edit various properties of expressions and dynamic content. For example, a user can add a content area to a given guidance page, such as create content area GUI element 352 for the alert page demonstrated in FIG. 7. The GUI 350 also includes an expression builder GUI component 354, which can be utilized to create a new expression (see, e.g., FIGS. 6A and 6B) as well as edit or delete an existing expression that has been created and stored as expression data. For example, a user can create new expressions as well as edit or delete expressions. In addition to managing expressions, the GUI 350 includes a guidance manager GUI component 356 such as for managing dynamic content to be populated to a corresponding area of a visualization space. The guidance manager GUI component 356 can be used to create new dynamic content as well as to edit and delete existing content. As an example, the expression E OR Area 358 has been assigned to dynamic content “E OR Emergencies 360 for a user-defined area of a visualization space indicated as alert page RHS. Other content shown in this example are similarly assigned to the same alert page for providing different dynamic content. As mentioned above, the same expressions can also be employed to provide different dynamic content including for the same or different visualization spaces.

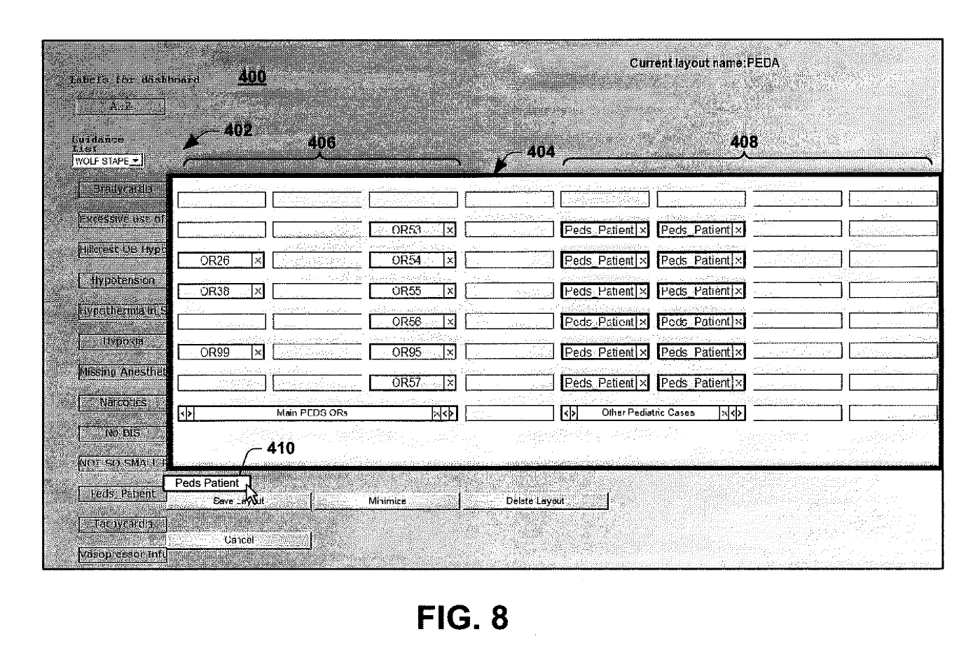

FIG. 8 depicts a screen shot of a GUI 400 that can be utilized for managing a layout 404 (e.g., layout configuration manager 240 of FIG. 2). The GUI 400 can be utilized to configure static elements and dynamic elements for the layout 404. In the example of FIG. 8, static layout elements 406 are configured by assigning locations such as different rooms (e.g., ORs) to selected layout elements. The dynamic elements 408 of the layout 404 can be configured by assigning to selected placeholders such as by dragging and dropping a selected expression (e.g., Peds Patient) 402 into to each respective placeholder to provide an additional dynamic layout element. For example, the expression GUI element 410 is demonstrated in the process of being moved to a placeholder. While in this example, all the dynamic layout elements are show as the same (e.g., Peds Patient), it is understood that any expression from the set of available expressions 402 can be utilized to configure the dynamic layout according to the preferences of the user. In this way, a selected set of GUI elements can be populated in the layout based upon the types of guidance and conditions that a given user may wish to visualize in a layout.

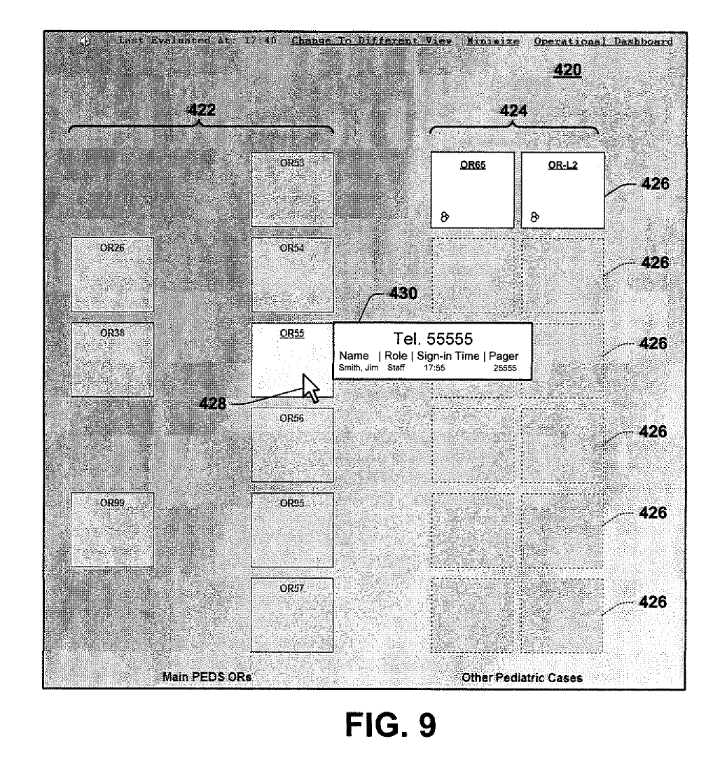

By way of example, FIG. 9 depicts a screen shot of an example layout GUI 420 that includes encounter GUI elements that are static (e.g., they are present in the layout regardless of expressions and conditions that might exist) demonstrated at 422 and GUI elements that are dynamically driven by a corresponding expression, demonstrated at 424. A plurality of placeholders 426 can be provided in the visualization space provided by the layout GUI 420. However, at this stage only a proper subset of such placeholders 426 are populated with encounter GUI elements (e.g., indicated at OR65 and OR-L2) based upon the expression that has been assigned to each the place holders (e.g., by the layout configuration manager 240 of FIG. 2 and shown in FIG. 8). The other placeholders 426 in the dynamic layout remain empty although can be filled when the expression assigned to each respective holder is satisfied. In the example of FIG. 9, the dynamic layout in the visualization space 420 is demonstrated as an expression, indicated as other pediatric cases, such that the placeholders 426 can be populated with encounter GUI elements for each active encounter involving a pediatric patient (as defined by the expression).

As mentioned above, different placeholders can be assigned different expressions according to user requirements. Thus, in a given hospital or other type of health care facility or group of facilities, only each encounter meeting the criteria established by the assigned expression for each placeholder 426 is populated with a corresponding GUI element. Accordingly, by managing which expressions are assigned for each placeholder, a given user can create a custom layout that can be dynamically populated with GUI elements to visualize encounters meeting user-defined criteria. Also show in FIG. 9, a user can employ a cursor 428 to hover over a selected encounter GUI element to reveal additional information 430 about the encounter or the location where the encounter resides.

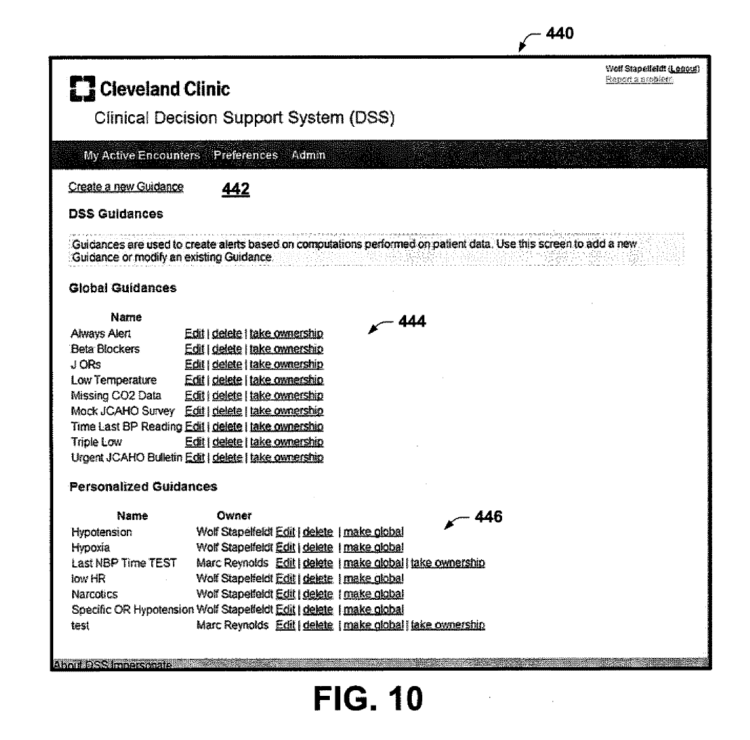

FIG. 10 depicts an example of screen shot 440 that includes a guidance management user interface 442 that can be utilized to create or edit or delete rules that are utilized by the guidance engine. For instance, the guidances can include global guidances 444 and personalized guidances 446. The alerts generated for a given guidance element can be performed based on computations that are performed by the guidance engine according to the patient data that is acquired by the DSS and an expression assigned to such guidance.

As mentioned above, the global guidances 444 can be utilized to set global guidances that are provided to each user and can be created and modified by authorized users, such as a supervisor. Examples of global guidance that can be utilized for the example of an anesthesia decision support system can include: alerts related to the use of beta blockers; low temperature for a patient; missing carbon dioxide data; the time that has elapsed from a last blood pressure reading; the triple low, or an urgent relevant article from the Journal of Anesthesiology. Each of the global guidances can be created or modified by the authorized user to result in corresponding guidance being provided for each encounter of each user via the DSS.

Personalized guidances 446 can also be created for a given user. The personalized guidances 446 can be converted to global guidances via an authorized user. The owner of a given personalized guidance element 346 can also be identified and corresponding user interface elements can be provided for editing, deleting or converting a personalized guidance to a global guidance, as demonstrated by the user interface elements that provide the personalized guidances 446. Guidance can be created for the encounter window that is generated by the DSS as well as for dashboarding that is implemented by the DSS system such as disclosed herein.

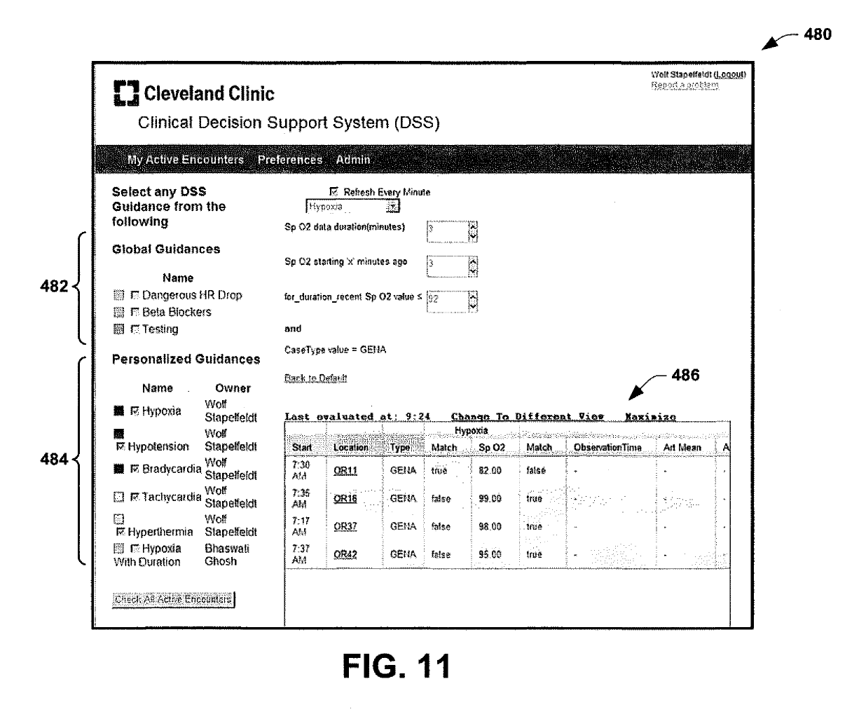

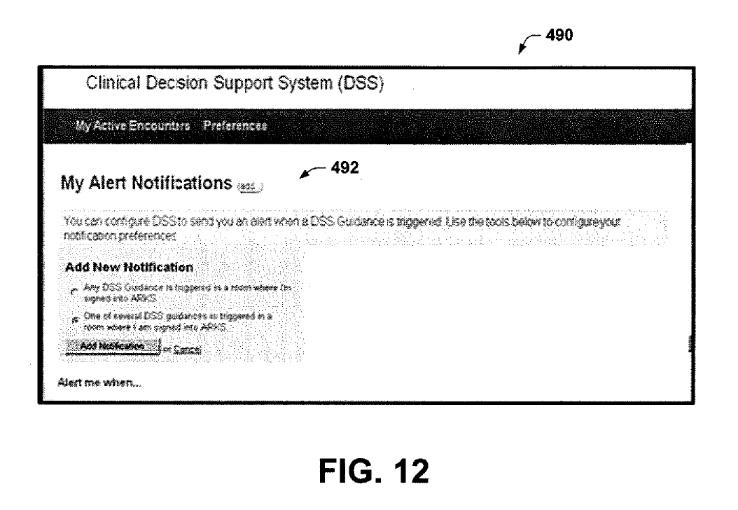

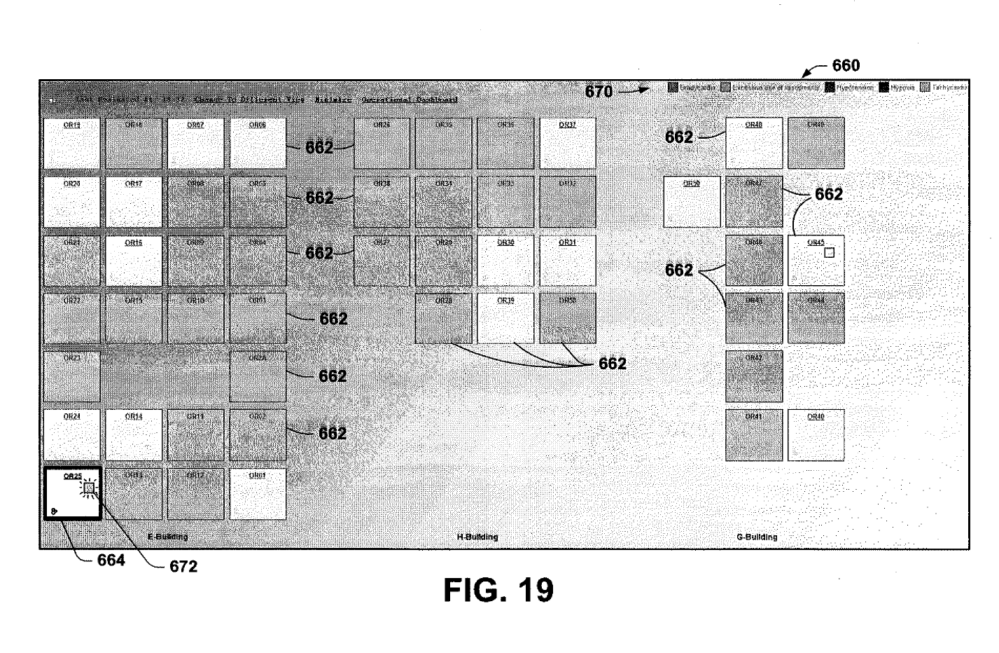

A supervisor-user can also employ a control desk and the DSS manager to configure global and personalized guidances via DSS administrator GUI 480, such as demonstrated in FIG. 11. The DSS administrator GUI 480 can be utilized to view and configure additional information about various guidances that may be provided by a dashboard GUI (see, e.g., FIG. 19).

In the example of FIG. 11, no global guidances have been selected in a global guidances GUI element 482. Personalized guidances for hypoxia, hypertension, bradycardia, and hypothermia have been selected in a personalized GUI element 484. Other types of guidance can also be configured for triggering corresponding alert conditions. Each alert condition can also be assigned a corresponding icon and/or color code via the GUI 482 for differentiating between such alert conditions. This selection of alert conditions can also result in details associated with such conditions being displayed in the corresponding display window 486. Details about the refresh rate and criteria for triggering the dashboard alerts can also be set via the GUI 482. In this way a given user can ascertain information about particular guidances that can be arranged and sorted according to each location or station for the selected guidances. Color coding can also be utilized in the display window 486 to identify particular parameters that may be below prescribed threshold levels for the encounters associated with any number of respective stations.

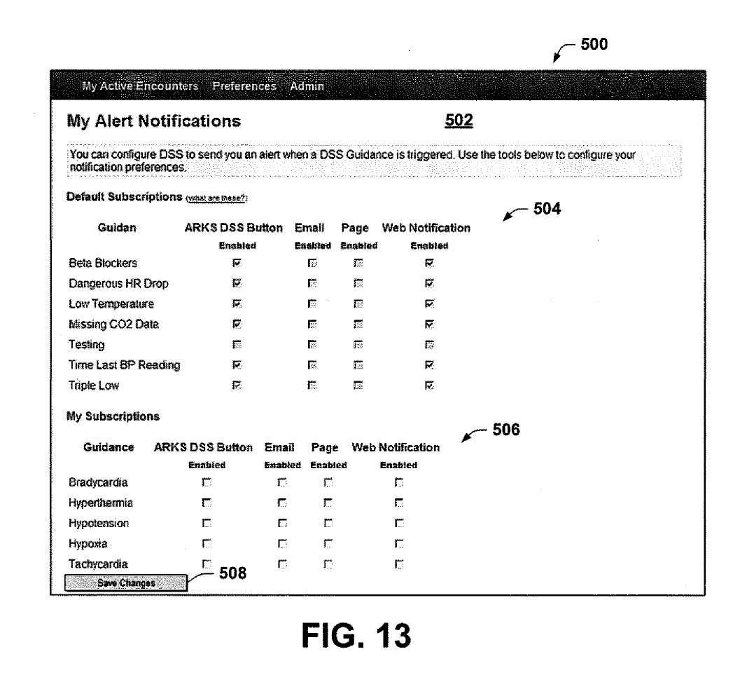

FIG. 12 depicts an example screen shot 494 that includes an example of a MY ALERT NOTIFICATIONS GUI 496 for a user that has been logged into the system. In the example GUI 496, the notifications can be utilized to set delivery preferences for notifications, such as for controlling criteria relating how to provide the notifications and to where such notifications should be provided. For instance, a user can select to have any guidance (e.g., all available guidances—global and personal) triggered in a station (e.g., an OR room) into which a given user is currently logged. In this way, the user will receive any notification for stations that the user is assigned to as the responsible user or owner. Alternatively, a user can select to have one or more types of DSS guidance provided as alert notifications to the user, such can be selectively configured by the user as demonstrated with respect to FIG. 13.

FIG. 13 depicts an example screen shot 500 of a MY ALERT NOTIFICATIONS GUI 502 that can be utilized for setting preferences regarding distribution of guidance that can be provided in the form of alert notifications to a given user. In the example of FIG. 13, the GUI 502 can subscribe to any available DSS guidance such as can be assigned via a guidance manager. There are two sets of guidance demonstrated in FIG. 13 global guidance (demonstrated as default subscriptions) 504 and personal guidance (demonstrated as My Subscriptions) 506. Each set of guidances 504 and 506 includes a list of various forms of guidance that can be provided in the form of notifications.

In the example of FIG. 13, a user can enable one or more forms of notification by selecting respective user interface elements (e.g., selection boxes) for providing alerts for each selected type of guidance (e.g., via a DSS button (found on another application, such as the encounter server), email, pager and web notification). Thus, a user can select a type of guidance and its manner in which each notification will be distributed to the user via a user input device. The settings can be saved to DSS data by clicking the “Save Changes” user interface element (e.g., a button) 508.

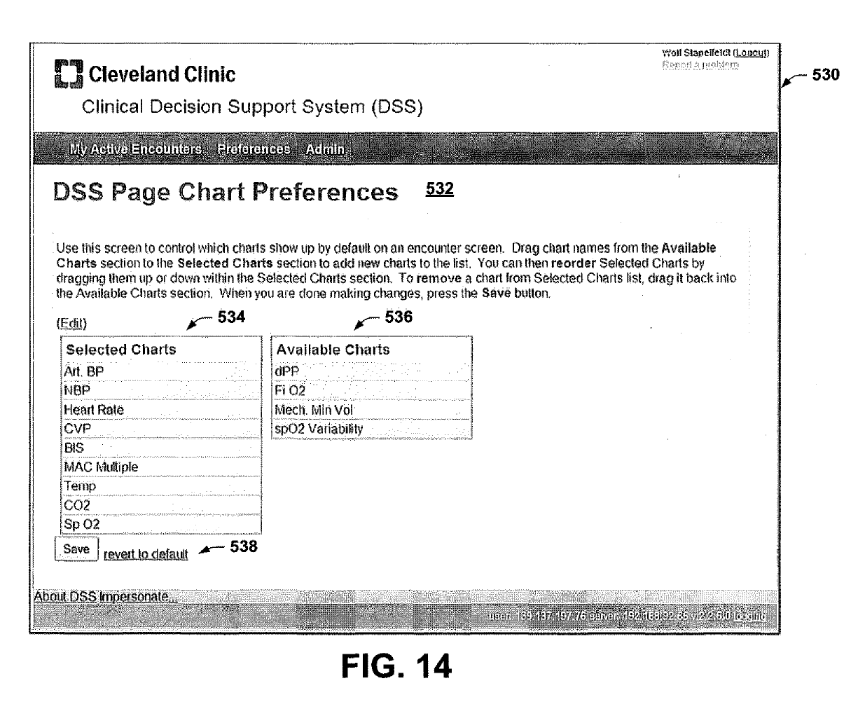

FIG. 14 depicts an example of screen shot 530 demonstrate an example of a DSS page chart preferences GUI 532 that can be implemented as part of a DSS. In the example of FIG. 14, the page chart preferences GUI 532 can be utilized to configure the layout of a given DSS user interface window, including what types of charts and data are to be presented for a given user and their presentation order. Thus the page chart preferences can provide personalized preferences that can be implemented for each given user that is logged into the system. In the example of page chart preferences GUI 532, a first set of charts are indicated at selected charts 534 that defines a set of charts that are to be presented in the DSS encounter window. Another user interface element, demonstrated as available charts 536, presents a set of charts that are available that can be added to an encounter window. A user thus may drag and drop chart elements between GUIs 533 and 536 to configure the layout and types of information that will be presented in the encounter window for the respective user. The corresponding selected charts can be saved via corresponding user interface element 538.

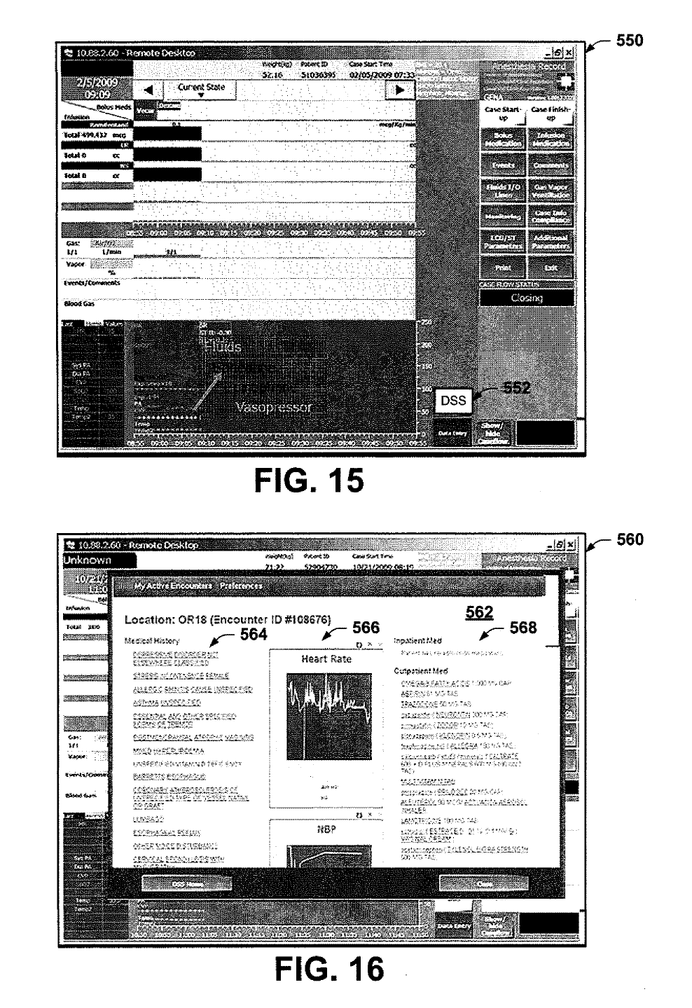

FIG. 15 depicts an example screen shot 550 such as corresponding to a monitoring system that may be implemented in a patient's station. In the example of FIG. 15 and other examples herein, the screen shot corresponds to a remote desktop associated with such equipment, such as generated by the encounter server for given station. In FIG. 15, a GUI (DSS) 552 can be activated to evoke the DSS web server and the functionality shown and described herein. Thus it is understood that the DSS server can be accessed in conjunction with other equipment and applications to provide corresponding decision support. The GUI element 552 can be in the form of a button, a hypertext link, a drop down menu or other elements that can be activated via a user input device (e.g., touch screen, mouse or the like).

FIG. 16 depicts an example screen shot 560 demonstrating an encounter GUI 562. In the example of FIG. 16, the encounter GUI 562 can include a variety of sections for providing information associated with a given patient encounter at a given station, demonstrated as operating room (OR) 568. In FIG. 16 the demonstrated sections can include a medical history section 564, a patient vitals section 566 as well as a patient medication section 568. Each of such sections 564, 566, and 568 can be populated with information that is acquired by the DSS or is generated by the DSS and provided to the user.

In addition to the various sections just described, the DSS can provide a plurality of user interface elements (e.g., in the form of buttons, drop down menus, or the like) that can be utilized for accessing additional types of patient information and functions for a given encounter or a dashboard GUI for viewing a plurality of encounters. Such additional patient information and functions can include, for example, a drug dose calculator, a CLX algorithm, clinical guidelines, an E-textbook, medications, ECG information, chest x-ray for the patient, lab results, echocardiogram information, cardiac catheterization information and carotid ultrasound results. By activating a GUI element to select one of these or other related items, corresponding information, graphs, images or the like can be presented in a corresponding DSS window that is presented to the user in substantially real time.

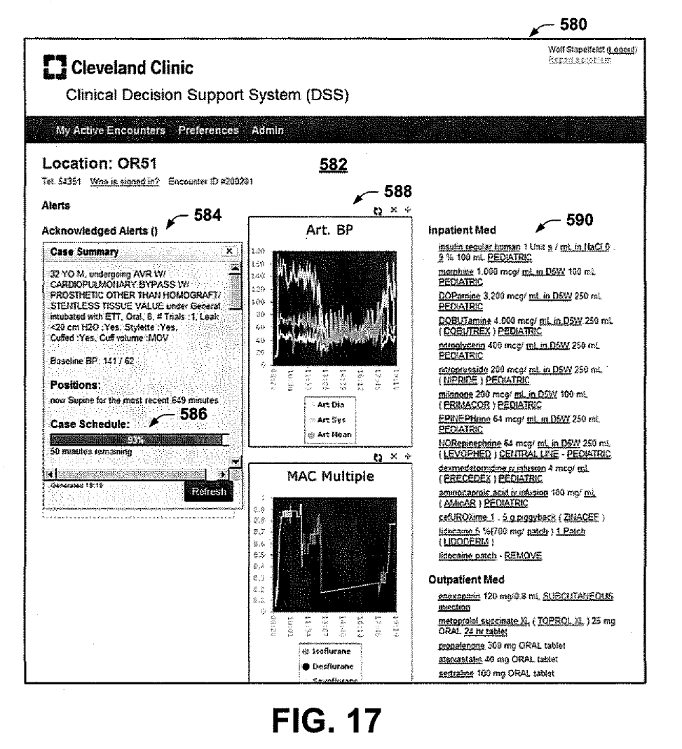

FIG. 17 depicts an example of another screen shot 580 demonstrating additional information that can be provided as part of an encounter GUI of the DSS. Beneath an alerts section is a case summary section 584 of the evolving patient encounter, including a case scheduling 586 indicating an estimated time remaining for a procedure. Also shown in the encounter GUI 582 of FIG. 17 are patient vitals 588, including arterial blood pressure and a MAC multiple, and a patient medications section 590, including sections for both inpatient medications and outpatient medications relevant for the given patient encounter.

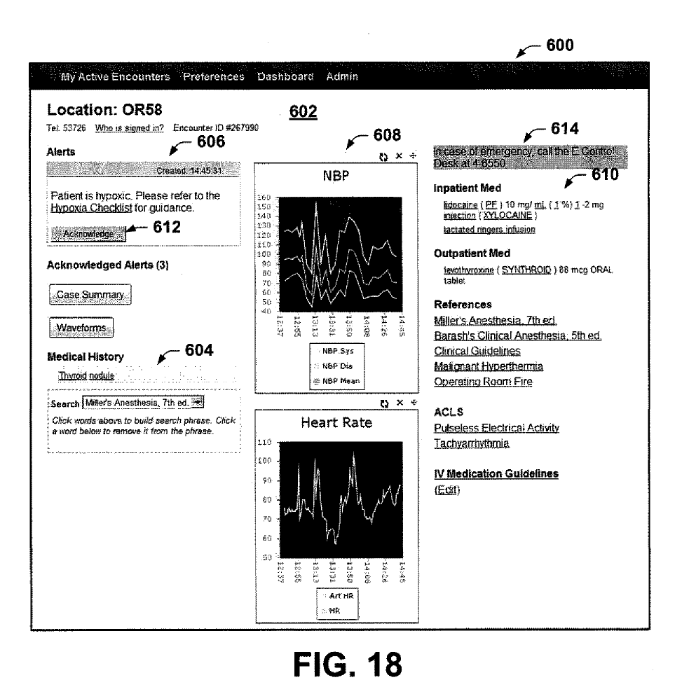

FIG. 18 depicts an example screen shot 600 that includes a DSS encounter window 602 that can be provided by the DSS web server as an interactive GUI. The DSS encounter window 602 provides information associated with a given encounter located in OR58, for example. In the DSS encounter window 602, dynamic content and passive content can be provided such as including medical history section 604, an alert section 606, a patient vital section 608 and a patient medication section 610. Each of the sections thus provides information associated with the given patient encounter, which is a currently active encounter assigned to a given user that has been logged into the system.

In the example of FIG. 18, the alert section 606 can indicate one or more alert condition, such as that the patient is hypoxic. Other alert conditions can also be indicated in the alert section 606. Also associated with the alert section 606 is an “acknowledge” button, indicated at 612, which allows a user to acknowledge the alert that has been generated. By including such an acknowledgement for a given patient encounter, assurances can be made and recorded (e.g., in memory) that a given user has been informed and has acknowledged the information for a given alert. The guidance engine further can be programmed, for example, to send additional alerts to the user as well as one or more other users associated with the encounter if the alert is not acknowledged within a predetermined programmable period of time (e.g., programmed as part of the alert notification). For instance, the alert reminder can be sent to the user that is responsible for the encounter as well as the supervisor and other individuals that may be identified as recipients for the notification. Again, the alert, regardless of how it is communicated to the user, can include means to confirm that the user has received and acknowledged the information such as by sending a corresponding response to the system. Additionally, the encounter window 602, the user's alert notification and the means for acknowledging it can be accessed via a user device, such as a remote device including a two-way pager, personal digital assistant, mobile device, computer or the like.

In conjunction with an alert section 606 an alert is being provided to indicate hypoxia (e.g., oxygen level is below a user-defined or default threshold), additional guidance to the hypoxia condition can be presented in the alert section 606, such as by providing a link to a “Hypoxia Checklist” or other passive guidance. For example, in response to the alert condition, guidance can also be programmed to provide emergency contact information, indicated at 614, such as can include a telephone number or other contact information for a user to call. The guidance at the area 614 be dynamically generated based on the OR (or other location) where the patient is located, for example.

Additionally, the background of the DSS encounter window 602 can be color coded to indicate whether an alert condition or warning condition or a normal condition exits for the current patient's encounter, which can be displayed in the current station (e.g., an OR) or for some other patient in some other location, so as not to have the displayed information accidentally applied to the current patient. For instance, an alert condition can turn the background red or otherwise provide a mechanism via text, graphics, audio or a combination thereof to indicate that the displayed DSS information pertains to another patient than the one currently being cared for in the location where this information is being viewed.

FIG. 19 demonstrates an example dashboard GUI 660. The dashboard GUI 660 can provide a supervisor a graphical view of the status of patient encounters for stations across any number of one or more facilities. In the example of FIG. 19, the dashboard GUI 660 includes a layout arranged according to a floor plans of different stations (e.g., OR's) located in three buildings, demonstrated as E Building, H Building and G Building. In the example of FIG. 19, a plurality of encounter GUI elements 662 can be presented with different colors to indicate different conditions. For instance, gray encounter GUIs can correspond to inactive stations. Yellow shaded encounter GUI elements can correspond to stations that have had alerts previous but have now been resolved. Additionally, a green shaded encounter GUI element can correspond to stations for normal patient encounters (e.g., no alert conditions).

By way of further example, when an alert condition is triggered, the encounter GUI 664 can identify the alert condition via a distinctive visual and/or audio indicator. In the example of FIG. 19, a bold border and a unique vibrant color (e.g., red) can be rendered on an encounter GUI element 664 to indicate an active patient encounter currently exhibiting an alert condition. Additionally, alert conditions, both past and present, can be indicated for each encounter GUI element according to a color coded legend 670, in which each color can indicate a different alert condition. The alert can be identified for a given station by displaying an interactive icon (e.g., a square or other shape) 672, having the color according to its type of alert, on each station for which an alert condition applies. Current alerts can be indicated in a manner to distinguish from resolved alert conditions, such as displaying a solid icon for ongoing alerts and a hollow icon for resolved alert conditions. Additionally, for new alert conditions (e.g., within the first 10 seconds or more), the icon 672 can be made to flash or blink to be more noticeable to a user. Additional information about each alert condition can be provided to the user (e.g., in the form of text and/or graphics-similar to as shown in FIG. 9) by hovering a cursor over or near the alert icon 672. Similar information can be provided for resolved alert conditions by hovering over the respective icons. In this way, the dashboard GUI 660 can allow a supervisor user to address adverse physiologic developments before they become crises and further control staff assignments according to needs of the various stations that maybe associated with a given location.

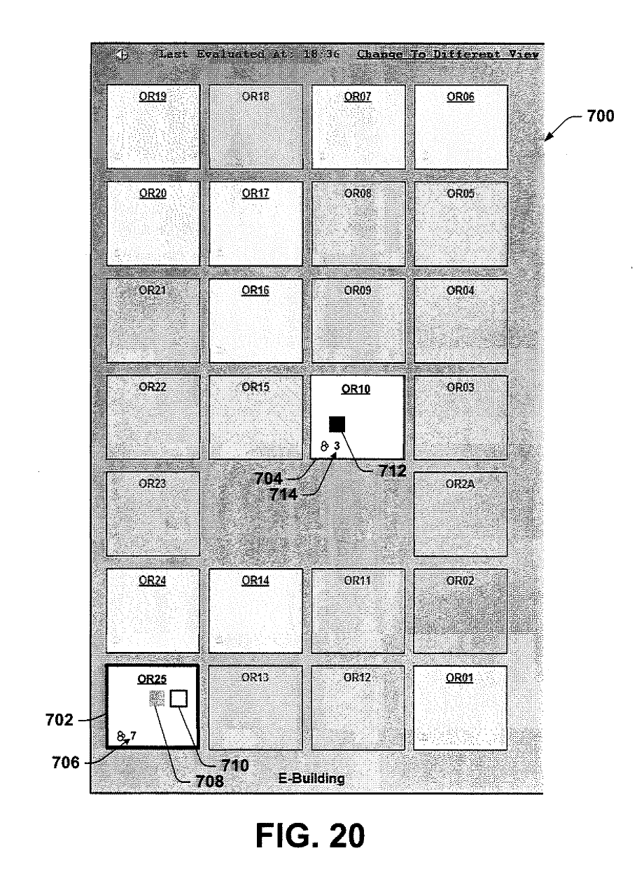

FIG. 20 demonstrates part of a dashboard GUI 700 to demonstrate an example of how a persisting alert condition can be presented. In the example of FIG. 20, two encounter GUI elements 702 and 704 indicate alert conditions. The GUI element 702 can correspond to an alert condition that has persisted for greater than a predetermined time period (e.g., five minutes or other programmable time). In this scenario, the border of the GUI element 702 can be emphasized to indicate the persisting alert condition. Additionally, for a GUI element that provides an alert condition for greater than a predetermined time period (e.g., about five minutes), in addition to the encounter GUI element maintaining the appearance of the alert condition (e.g., by a visual indicator, such as a red color, to indicate an alert condition), a timer 706 may be populated on or adjacent to the encounter GUI element. The timer 706 can indicate the time for which the alert condition has persisted for the encounter (e.g., the number “7” in the lower portion thereof). If more than one alert condition has persisted for the same encounter, the timer can indicate the longest duration alert or a decision can be made (e.g., based on dynamic expressions) to ascertain which alert condition is most severe. Interactive icon elements 708 and 710 can be populated within the GUI element 702 for each alert condition, including the persisting condition at 710. The other alert condition 708 can correspond to a resolved alert condition, for example.

The encounter GUI element 704 also is experiencing a persisting alert condition corresponding to the alert condition represented by the icon at 712. A timer 714 also demonstrates the duration of the persisting alert condition. In this example, however, it is determined that the alert has not lasted for at least a predetermined time period (e.g., it has lasted for about 3 minutes) such that the border of the encounter GUI element 704 is not yet made bold like the other GUI element 702.

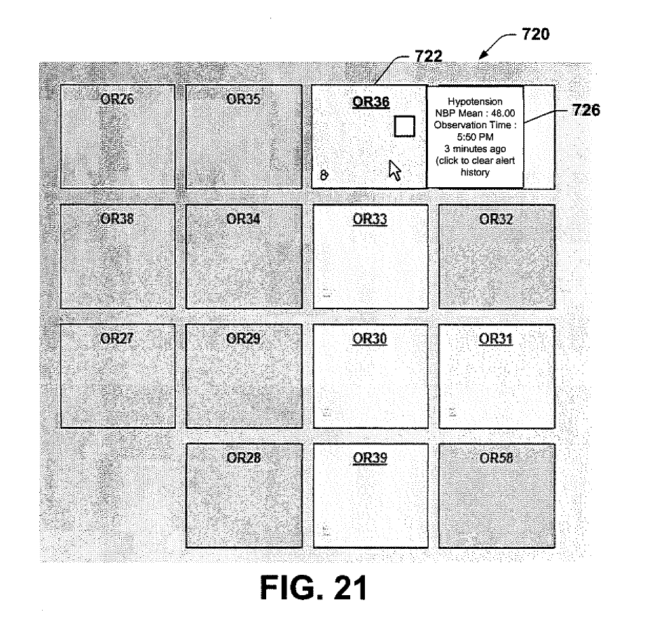

As disclosed herein, the DSS system can control the visualization of an alert GUI element by gradually changing the appearance of the GUI element after the alert condition has resolved itself. For example, FIG. 21 demonstrates a portion of a dashboard GUI 720 (e.g., part of the GUI 660 from FIG. 19) to show an example of an encounter GUI element 722 that had previously indicated an alert condition that had been resolved. Thus, the encounter GUI element 722 is in a process of gradually changing from the resolved condition back to a normal condition. After an alert condition for a given encounter GUI element has resolved, the encounter GUI element can change conditions such by changing from an alert background color (e.g., red) to a second color (e.g., yellow), such as in response to determining alert condition has been resolved.

For example, the encounter GUI element 722 can change from this second color to a third color (e.g., green) gradually over time. The duration of the transition may be programmable. During this transition period, the encounter GUI element 722 can gradually change colors from the second color (e.g., yellow) to a third color (e.g., green). In this way, the changing color demonstrates that an alert condition had once existed for the GUI element and the color of it can also provide an indication of the time since the alert condition had terminated. For example, by hovering over the encounter GUI element with a pointer or touch screen or other form of selection, information about the previous alert can be presented on or adjacent to the encounter GUI element, such as indicated at 726.

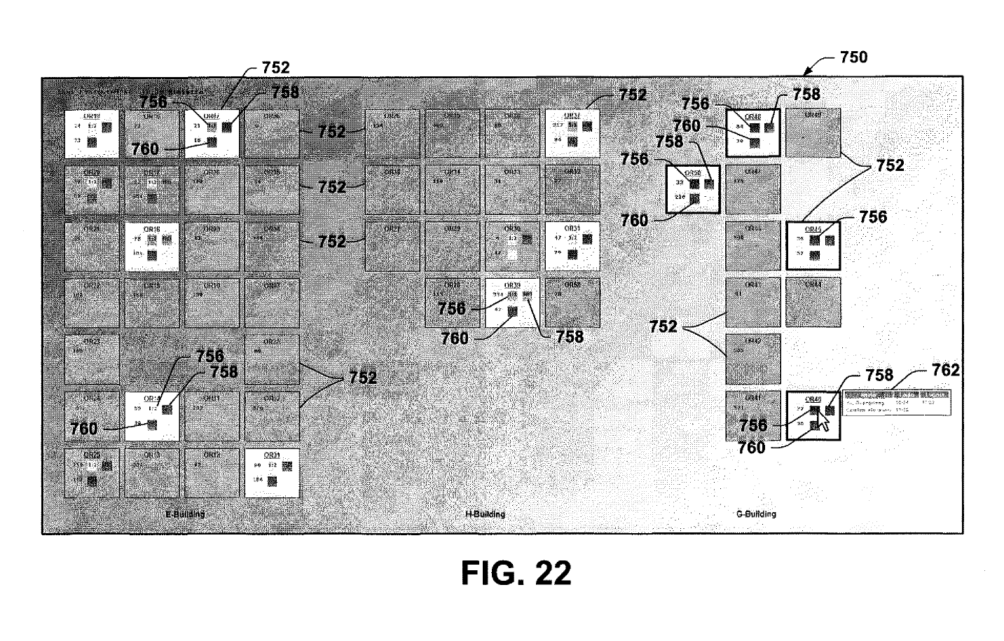

FIG. 22 depicts an example of an operational dashboard GUI 750 that can be populate a visualization space with information about business operations, such as can include staffing information, procedure information and related status information. The operations GUI 750 can also provide guidance, such as including alert conditions or other guidance (e.g., dynamic and/or passive guidance). Additionally the layout for the operations GUI 750 can be implemented as a static layout, a dynamic layout or it can include a combination of static and dynamic elements as disclosed herein.

The operations GUI 750 can include a plurality of encounter GUI elements 752, such as corresponding to encounter GUI elements that present operational guidance for each active encounter that is being visualized in the GUI. In the example of FIG. 22, the encounter GUI elements can correspond to rooms (e.g., OR's) in three different buildings of a healthcare facility. The buildings can be together at a single campus or be distributed throughout one or more states or even reside in different countries.

The operations dashboard GUI 750 can provide operational guidance based on inputs from a variety of data sources programmed to track or monitor various aspects of operations or that can be derived from such data sources according to user-defined expressions. For example, a given user (e.g., physician or other health care provider) may be required to log into or otherwise become associated with a respective encounter by logging into one or more station for a given encounter. This can be done manually via a user input device (e.g., keyboard or mouse) or by swiping an access card upon entry into a card reader at or the station or a nearby preparation area.

The DSS can be programmed to apply the input information to one or more expressions that have been assigned to provide operational guidance. For example, the DSS (e.g., the guidance engine) can compute ratios of concurrent staffing (a concurrency ratio) that can be presented at each encounter GUI element 752 that is active. An inactive encounter can remain unpopulated with information (e.g., it can be grayed out). Other forms of operational guidance and status information can also be presented for each encounter, such as can include clinical status as well as other operations information, such as disclosed herein.

By way of example, the encounter GUI elements 752 in the operational dashboard GUI 750 can dynamically indicate the number of staff anesthesiologist (or other types of persons) signed into a case. This can change over the course of the encounter. For instance, the encounter GUI elements 752 can be color coded to provide guidance that indicates the number of anesthesiologists (e.g., green 1; yellow 2; orange 3; red 4 or more).

Other icons or other interactive elements (e.g., demonstrated as small boxes) 756, 758 and 760 within the encounter GUI elements 752 can be utilized to provide other types of high-level operational status information. For example, the interactive elements 756 may indicate a concurrency ratio for a given provider (e.g., an anesthesiologist). For example, different colors can indicate different concurrency ratios (e.g., red 1:0; orange 1:1; yellow 1:2; green 1:3; blue 1:4). Additional relevant details about the concurrency ratio can also be presented as text within the element 756. The elements 758 can indicate a type of health care provider. For example, different colors and accompanying text information can indicate different types of providers (e.g., green C: CRNA; orange MD: resident; yellow S: SRNA). Additional details about such staff can be presented in response to selecting or hovering over the elements 756 and 758, such as who the person is, contact information, when they signed in and the like. The interactive elements 760 in each active encounter can be utilized to provide clinical guidance information, such as whether any alert condition exists. For example, the elements 760 can correspond to the information provided as dynamic guidance (e.g., alert guidance) for the respective encounter and employ the same color coding scheme. Similar to the other interactive elements 756 and 758, additional information about the clinical status can be presented to the user (e.g., as a pop-up) in response to selecting or hovering over the elements 760. For example, in response to a user input (e.g., hovering a cursor over interactive element 756 for OR40), a text-window 762 can be generated to provide additional information, such as indicating who has signed in to the encounter as well as their login and logout times.

Additional text-based information can also be presented within or near each active encounter GUI element 752. The text can include numbers representing timing information. For example, the numbers can dynamically indicate the number of minutes for which the most recent staff anesthesiologist has been signed into the case. Another number may indicate the number of minutes remaining in the case based on an estimated or scheduled duration. The number further can be presented with bold and/or colored font, such as to indicate that the encounter has exceeded its scheduled time limit. Other timing information relevant to operational guidance can be provided in the operational GUI 750, which can be customized according to user requirements.

As will be appreciated by those skilled in the art, portions of the invention may be embodied as a method, data processing system, or computer program product. Accordingly, these portions of the present invention may take the form of an entirely hardware embodiment, an entirely machine readable instruction embodiment, or an embodiment combining machine readable instructions and hardware. Furthermore, portions of the invention may be a computer program product on a non-transitory computer-usable storage medium having machine readable program code on the medium. Any suitable computer-readable medium may be utilized including, but not limited to, static and dynamic storage devices, hard disks, optical storage devices, and magnetic storage devices.

Certain embodiments of the invention are described herein with reference to flowchart illustrations of systems and computer program products. It will be understood that blocks of the illustrations, and combinations of blocks in the illustrations, can be implemented by machine-readable instructions (e.g., including those demonstrated by the DSS server 12 of FIG. 1 and related systems 100, 150, 200 and 230 of FIGS. 2, 3, 4, and 5, respectively). These machine-readable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These machine-readable instructions (e.g., as demonstrated by the DSS server 12 of FIG. 1 and related systems 100, 150, 200 and 230 of FIGS. 2, 3, 4, and 5, respectively) may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions disclosed herein.

What have been described above are examples of the invention. It is, of course, not possible to describe every conceivable combination of components or methodologies, but one of ordinary skill in the art will recognize that many further combinations and permutations of the invention are possible. Accordingly, the invention is intended to embrace all such alterations, modifications and variations that fall within the scope of the appended claims and the application. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.

What is claimed is:

1. A system to facilitate decision support comprising:
dynamic expression data stored in memory, the dynamic expression data including a plurality of expressions, each expression representing a different clinical condition that varies as a function of one or more variables;
a user interface programmed to assign a given expression to a selected visualization space in response to a user input;
an interface to receive values from at least one data source for each variable in the given expression;
an output engine programmed to populate the selected visualization space with information based on each condition defined by the given expression that has been assigned to the selected visualization space.

2. The system of claim 1, wherein the visualization space comprises a layout, the output engine controlling the layout based on each condition defined by the given expression that has been assigned to each area of the layout.

3. The system of claim 2, wherein each area of the layout includes placeholders, the output engine being programmed dynamically populate the layout with a corresponding visualization based on the given expression that has been assigned to each respective placeholder.

4. The system of claim 3, wherein the placeholder comprises a portion of the visualization space programmed to represent at least one of a clinical condition or a clinical location, the output engine dynamically populating each respective with an encounter graphical user interface element based on a value of the one or more variables of the given expression that has been assigned to each respective placeholder.

5. The system of claim 4, wherein different placeholders of the visualization space are assigned different ones of the plurality of expressions in response to an assignment user input.

6. The system of claim 1, wherein the visualization space comprises an alert guidance.

7. The system of claim 6, wherein the alert guidance comprises a global alert that is provided to each user that is logged in to the system in response to a corresponding alert condition being met based on a value of at least one variable in a selected one of the plurality of expressions that is assigned to the global alert.

8. The system of claim 6, wherein the alert guidance comprises a personalized user-specific alert that is provided to a respective user based on a value of at least one variable in a selected one of the plurality of expressions that is assigned to the personalized user-specific alert.

9. The system of claim 6, wherein the alert guidance further comprises guidance data that is computed based on the selected one of the plurality of expressions having value that defines when a corresponding alert condition is active, the guidance data having a mode for controlling a visualization of the alert condition in the visualization space based on a relative timing of when the alert condition is triggered.

10. The system of claim 9, further comprising a guidance component to control the visualization of the alert condition to differentiate between the alert condition and a subsequent non-alert condition that occurs after the alert condition is resolved based on the selected one of the plurality of expressions.

11. The system of claim 10, wherein the guidance component is programmed to gradually transition the visualization from the subsequent non-alert condition to a predefined normal condition over a predetermined time period, information about the alert condition being available during the transition in response to a predetermined user input but not available in the visualization space after the transition.

12. The system of claim 10, wherein the guidance component is programmed to control the visualization of the alert condition by graphically discriminating between initial alert condition and persisting alert condition, an indication of a duration for the persisting alert condition being presented in the visualization space.

13. The system of claim 1, wherein the one or more variables comprises a real-time variable, the interface being configured to receive substantially real-time input data to enable the output engine to analyze the given expression and provide guidance in substantially real time in based on a value of the real-time input data corresponding the one or more variables in the given expression that is assigned to the visualization space.

14. The system of claim 1, further comprising an expression builder programmed to generate a dynamic expression in response to a user input selecting the one or more variables to define a corresponding clinical condition.

15. The system of claim 14, wherein the dynamic expression comprises an n-dimensional expression corresponding to an evidence-based surface function, where n is a positive integer greater than one denoting the number of the one or more variables.

16. The system of claim 14, wherein the expression builder comprises a graphical user interface programmed to drag and drop a graphical user interface element corresponding to the selected variable into an expression container interface element to create a relationship between two or more variables in the expression, the relationship being programmable in response to a selection user input.

17. The system of claim 1, further comprising an operational dashboard graphical user interface, which provides an operational visualization space, programmed to provide operational information based on staffing data and timing data associated with each encounter graphical user interface element that is populated in the operational visualization space.

18. The system of claim 1, wherein the output engine comprises a layout component programmed to dynamically populate at least a portion of the visualization space with encounter graphical user interface elements for each encounter based on the given expression that has been assigned to respective areas of the visualization space; and
a guidance component programmed to dynamically populate each encounter graphical user interface element in the visualization space with guidance information based on the given expression that has been assigned to each respective encounter graphical user interface element.

19. The system of claim 18, wherein the plurality of expressions employed by the layout component and the guidance component comprise a common set of expressions.

20. A graphical user interface (GUI) to provide clinical decision support, comprising:
a GUI element associated with a patient encounter, the GUI element being presented in a visualization space and programmed to provide a status feature for a given alert condition that graphically discriminates between an alert condition and a non-alert condition for a given alert guidance based on a given expression that is assigned to the given alert guidance,
after the alert condition is resolved, the status feature being changed gradually over a predetermined time from indicating the alert condition to indicating the non-alert condition.

21. The GUI of claim 20, further comprising controls to gradually transition a visualization of the status feature from the non-alert condition to a predefined normal non-alert condition over a predetermined time, information about the alert condition being available during the transition in response to a user input, but not available in the visualization space after the transition to the predefined normal non-alert condition.

22. The GUI of claim 21, wherein the status feature comprises a color of an encounter GUI element that is presented in the visualization space.

23. The GUI of claim 22, wherein the color of the status feature comprises a first color assigned to the alert condition, a second color assigned to the non-alert condition immediately after the alert condition is resolve and a third color assigned to the predefined normal non-alert condition, the controls gradually changing the color of the status feature from the second color to the third color over the predetermined time.

24. The GUI of claim 21, wherein the predetermined time is programmable in response to a user input.

25. The GUI of claim 20, graphically differentiating between initial alert condition and persisting alert condition, an indication of a duration for the persisting alert condition being presented in the visualization space.

26. The GUI of claim 20 implemented in a decision support system, the decision support system comprising:
dynamic expression data stored in memory, the dynamic expression data including a plurality of expressions, each expression representing a different condition that varies as a function of one or more variables;
an assignment user interface programmed to assign a user-selected expression to a selected visualization space in response to a user input;
a data interface to receive input data from at least one data source for each variable in the given expression;
an output engine programmed to populate the selected visualization space with information based on each condition defined by the given expression that has been assigned to the selected visualization space, including the given alert guidance.
